(19) United States
(12) Patent Application Publication
(10) Pub. No.: US 2026/0010398 A1
(43) Pub. Date: Jan. 8, 2026

(54) JOB MANAGEMENT SYSTEM AND INFORMATION PROCESSING METHOD

(71) Applicant: Fujitsu Limited, Kawasaki-shi,Kanagawa (JP)

(72) Inventors: Ibuki OKAMOTO, Kawasaki (JP); Yoshihiro KIMURA, Kobe (JP); Akinobu TAKAISHI, Kobe (JP); Naoki KOJIMA, Kobe (JP)

(73) Assignee: Fujitsu Limited, Kawasaki-shi,Kanagawa (JP)

(21) Appl. No.: 19/258,062

(22) Filed: Jul. 2, 2025

(30) Foreign Application Priority Data
Jul. 8, 2024 (JP) 2024-109742

(51) Int. Cl. G06F 9/48

(52) U.S. Cl. CPC G06F 9/4881

(57) ABSTRACT

A relay system transfers, upon receiving a first request that specifies first identification information of a job to request the start of execution of the job, from a first job management apparatus, the first request to a job execution system, receives returned second identification information, and stores the first identification information and the second identification information in association with each other in a storage unit. The relay system transmits a third request that specifies the second identification information to request status information, to the job execution system, and stores returned status information in association with the first identification information in the storage unit. When the first job management apparatus stops operation, a second job management apparatus takes over, from the first job management apparatus, a monitoring process of transmitting, to the relay system, a request that specifies the first identification information to request the status information.

### CROSS-REFERENCE TO RELATED APPLICATION

This application is based upon and claims the benefit of priority of the prior Japanese Patent Application No. 2024-109742, filed on Jul. 8, 2024, the entire contents of which are incorporated herein by reference.

### FIELD

The present embodiments discussed herein relate to a job management system and an information processing method.

### BACKGROUND

In recent years, jobs for various business processes are increasingly executed on cloud services. High availability is needed for the execution of such jobs on the cloud services.

For job management, the following techniques have been proposed. For example, a server system has been proposed in which a schedule management server is selected from a plurality of servers having a job registration request function, and if an abnormality occurs in the schedule management server, another server is selected according to a predetermined priority order, to execute the schedule management function in place of the schedule management server. In addition, a job execution system has been proposed in which, when a job execution server enters a system switching state during the execution of a job, a standby server collects job execution status information from the job execution server, determines a resumption point of the job flow based on the job execution status information, and instructs the job execution server to resume the job from the resumption point.

Furthermore, as a related technique, a system has been proposed in which, when a request proxy device that acts as a proxy for a request made from a requestor terminal to a first server detects a failure in the first server, the request proxy device reads out terminal request information from a request information management terminal and transmits the terminal request information to a second server, so that the second server continues the transaction for executing the request made from the requestor terminal, using the terminal request information. See, for example, the following literatures.
Japanese Laid-open Patent Publication No. 2007-249674
Japanese Laid-open Patent Publication No. 2010-140106
Japanese Laid-open Patent Publication No. 2008-27189

### SUMMARY

In one aspect, there is provided a job management system including: a first job management apparatus configured to perform an execution request process of transmitting a first request that specifies first identification information identifying a job to request a start of execution of the job, and a monitoring process of repeatedly transmitting a second request that specifies the first identification information to request status information indicating an execution status of the job, after the transmitting of the first request and until the status information returned in response to the second request indicates an end of the execution of the job; a second job management apparatus configured to take over the monitoring process from the first job management apparatus by using the first identification information; a relay system configured to perform a relay process that includes transferring, upon receiving the first request from the first job management apparatus, the first request to a job execution system that is to execute the job, receiving second identification information identifying the job from the job execution system and storing the first identification information and the second identification information in association with each other in a memory, transmitting, to the job execution system, a third request that specifies the second identification information to request the status information, and storing the status information returned from the job execution system in association with the first identification information in the memory, and obtaining, upon receiving the second request from the first job management apparatus or a fourth request specifying the first identification information from the second job management apparatus, the status information associated with the first identification information from the memory and transmitting the status information to the first job management apparatus having transmitted the second request or the second job management apparatus having transmitted the fourth request; and the job execution system configured to start, upon receiving the second request from the relay system, the execution of the job, assign the second identification information to the job, and transmit the second identification information to the relay system, and transmit, upon receiving the third request from the relay system, the status information of the job to the relay system.

The object and advantages of the invention will be realized and attained by means of the elements and combinations particularly pointed out in the claims.)

It is to be understood that both the foregoing general description and the following detailed description are exemplary and explanatory and are not restrictive of the invention.

### BRIEF DESCRIPTION OF DRAWINGS

FIG. 1 illustrates a job management system according to a first embodiment;

FIG. 2 illustrates a job management system according to a comparative example;

FIG. 3 illustrates an example of a configuration of a job management system according to a second embodiment;

FIG. 4 illustrates a hardware configuration of a physical machine;

FIG. 5 illustrates an example of a configuration of processing functions provided in the job management system;

FIG. 6 illustrates an example of a data structure of a job management table;

FIG. 7 illustrates an example of a data structure of a relay job management table;

FIG. 8 illustrates an example of operations that are performed at the start of execution of a job;

FIG. 9 illustrates an example of operations that are performed during the execution of the job;

FIG. 10 illustrates an example of operations that are performed at the time of failover;

FIG. 11 is a flowchart illustrating an example of a job execution management process performed by a job scheduler;

FIG. 12 is a flowchart illustrating an example of a job monitoring process performed by the job scheduler;

FIG. 13 is a flowchart illustrating an example of a job execution management process performed by a relay processing unit;

FIG. 14 is a flowchart illustrating an example of a job monitoring process performed by the relay processing unit;

FIG. 15 is a flowchart illustrating an example of a forced termination process performed by the job scheduler;

FIG. 16 is a flowchart illustrating an example of a forced termination process performed by the relay processing unit;

FIG. 17 is a flowchart illustrating an example of a process performed by a job scheduler after failover;

FIG. 18 is a flowchart illustrating an example of a monitoring request response process performed by the relay processing unit;

FIG. 19 illustrates a process that is performed when an abnormality occurs in the relay processing unit;

FIG. 20 is a flowchart illustrating an example of a process that is performed by a management unit in response to an abnormality occurring in the relay processing unit;

FIG. 21 is a flowchart illustrating an example of a process that is performed by the job scheduler in response to an abnormality occurring in the relay processing unit;

FIG. 22 is a first diagram illustrating an example of activation and deletion of a relay processing unit;

FIG. 23 is a second diagram illustrating an example of activation and deletion of a relay processing unit;

FIG. 24 illustrates tenant-dedicated relay processing units; and

FIG. 25 illustrates tenant-shared relay processing units.

### DESCRIPTION OF EMBODIMENTS

A process for causing a cloud service to execute a job on a cloud service in response to a request from a job management apparatus is performed, for example, in the following manner. When the job management apparatus requests the start of execution of the job, the cloud service starts the execution of the requested job. Thereafter, the job management apparatus periodically acquires status information indicating the execution status of the job from the cloud service. The job management apparatus performs such a monitoring process for the job until the execution of the job is complete.

When the job management apparatus operating as an active system has become unable to continue normal operation or has stopped due to occurrence of an abnormality during the execution of the job, a job management apparatus operating as a standby system transitions to the active system and takes over the monitoring process for the job. In this case, a problem to be addressed is what processes are needed to ensure that the job management apparatus that has transitioned to the active system is able to reliably take over the monitoring process for the job.

For example, when the cloud service starts the execution of a requested job, the cloud service assigns identification information that is unique on the cloud service side, to the job. In order to acquire the job status information of the job from the cloud service, the target job needs to be specified using the identification information assigned by the cloud service. However, it is difficult for the job management apparatus that has transitioned from the standby system to the active system to recognize the identification information.

Hereinafter, embodiments of the present disclosure will be described with reference to the drawings.

### First Embodiment

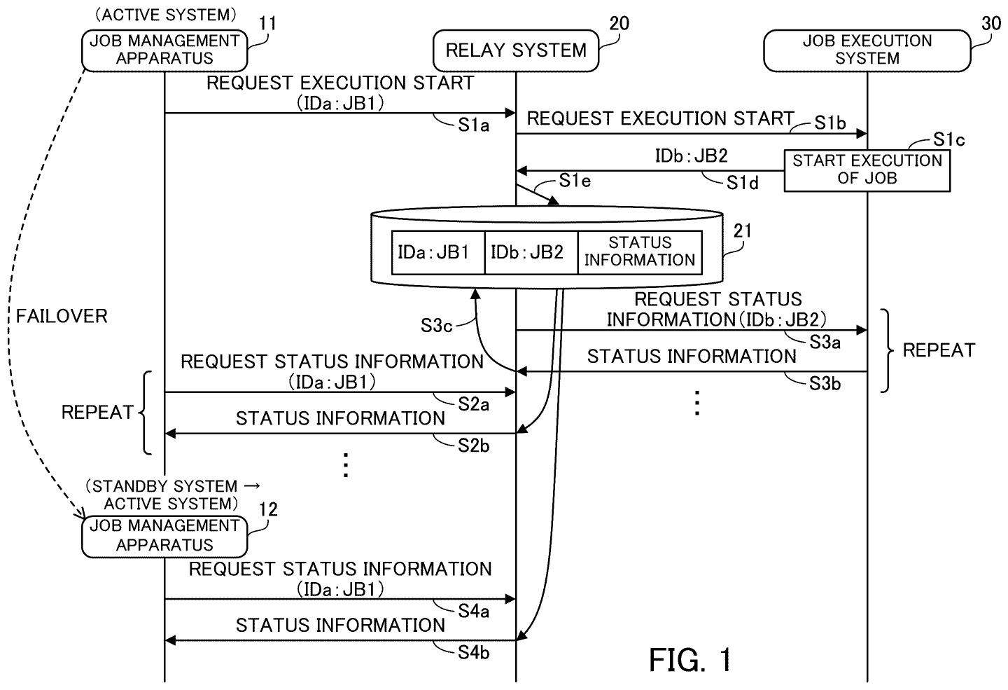

FIG. 1 illustrates a job management system according to a first embodiment. The job management system illustrated in FIG. 1 includes job management apparatuses 11 and 12, a relay system 20, and a job execution system 30.

The job management apparatuses 11 and 12 are physical machines (for example, server computers) or virtual machines. The job management apparatuses 11 and 12 cause the job execution system 30 to execute jobs via the relay system 20. One of the job management apparatuses 11 and 12 operates as an active system, and the other operates as a standby system. When the job management apparatus operating as the active system stops, the job management apparatus operating as the standby system transitions to the active system and takes over the process that has been performed by the stopped job management apparatus (failover).

The relay system 20 is a computer system including one or more physical machines (for example, server computers). The relay system 20 relays a job execution start request that is transmitted from the job management apparatus 11 to the job execution system 30. Further, the relay system 20 holds information needed when the job management apparatuses 11 and 12 fail over.

The job execution system 30 is a computer system including one or more physical machines (for example, server computers). The job execution system 30 is, for example, a cloud system provided by a cloud service. The job execution system 30 executes jobs in response to requests received from the job management apparatus 11 via the relay system 20.

The following describes a processing example of the job management system in a state where the job management apparatus 11 operates as the active system and the job management apparatus 12 operates as the standby system.

The job management apparatus 11 as the active system transmits, to the relay system 20, a first request specifying identification information IDa identifying a job to request the start of execution of the job (step S1a). The identification information IDa is information that the job management apparatuses 11 and 12 use to identify the job. Here, as an example, it is assumed that “JB1” is set as the identification information IDa.

When the relay system 20 receives the first request in which the identification information IDa “JB1” is set, the relay system 20 transfers the first request to the job execution system 30 to request the start of execution of the job (step S1b). Note that the identification information IDa “JB1” does not need to be set in the transferred request.

Upon receiving the first request, the job execution system 30 starts to execute the job (step S1c) and, at the same time, assigns identification information IDb to the job that has started execution and transmits the identification information IDb to the relay system 20 (step S1d). The identification information IDb is information that the job execution system 30 uses to identify the job, and is assigned regardless of the identification information IDa. Here, it is assumed that “JB2” is assigned as the identification information IDb.

Upon receiving the identification information IDb “JB2” from the job execution system 30, the relay system 20 stores the identification information IDb “JB2” in association with the identification information IDa “JB1” received in step S1a (step S1e) in a storage unit 21.

In the storage unit 21, status information indicating the execution status of the job is also registered in association with the identification information IDa “JB1”. At the time of step S1e, for example, information indicating that the job is waiting for execution may be registered as status information.

After transmitting the first request, the job management apparatus 11 transmits, to the relay system 20, a second request specifying the identification information IDa “JB1” to request the status information of the job (step S2a). Upon receiving the second request, the relay system 20 acquires the status information associated with the identification information IDa “JB1” from the storage unit 21, and transmits the acquired status information to the job management apparatus 11 (step S2b).

The relay system 20 acquires, from the storage unit 21, the latest status information at the time of receiving the second request, and transmits the latest status information. In the example of FIG. 1, after the status information is updated in step S3c described later, the second request is transmitted in step S2a. Therefore, in step S2b, the status information updated in step S3c is transmitted to the job management apparatus 11.

The job management apparatus 11 repeatedly transmits the second request, for example, at regular time intervals until the status information indicates the end of execution of the job. Therefore, steps S2a and S2b are repeatedly executed until the status information indicates the end of execution of the job. In the manner described above, the job management apparatus 11 manages the execution of the job using the identification information IDa.

Meanwhile, the relay system 20 transmits, to the job execution system 30, a third request specifying the identification information IDb “JB2” to request the status information of the job (step S3a). Upon receiving the third request, the job execution system 30 transmits status information indicating the execution status of the job to the relay system 20 (step S3b). For example, if a job is being executed, status information indicating that the job is in progress is transmitted, and if the execution of the job has ended, status information indicating the end of the execution is transmitted. The relay system 20 registers the received status information in the storage unit 21 to update the already-registered status information (step S3c).

The relay system 20 repeatedly transmits the third request, for example, at regular time intervals until the status information indicates the end of execution of the job. Therefore, steps S3a to S3c are repeatedly executed until the status information indicates the end of execution of the job. In the manner described above, the relay system 20 manages the execution of the job using the identification information IDb.

It is now assumed that an abnormality occurs in the job management apparatus 11 during the execution of the job. In this case, failover is performed, so that the job management apparatus 12 transitions from the standby system to the active system. The job management apparatus 12 having transitioned to the active system uses the identification information IDa to take over the management process for the job that has been performed by the job management apparatus 11.

Specifically, the job management apparatus 12 transmits, to the relay system 20, a fourth request specifying the identification information IDa “JB1” to request the status information of the job (step S4a). Upon receiving the fourth request, the relay system 20 acquires the status information associated with the identification information IDa “JB1” from the storage unit 21, and transmits the acquired status information to the job management apparatus 12 (step S4b). In the case where the status information indicates that the job is in progress, the job management apparatus 12 determines that the management process is needed for the job, and repeatedly transmits the fourth request in step S4a, as in step S2a. In the manner described above, the job management apparatus 12 takes over the management process for the job that has been performed by the job management apparatus 11.

In the job management system described above, the relay system 20 manages the identification information IDa of the job assigned by the job management apparatus 11 or 12 and the identification information IDb of the job assigned by the job execution system 30 in association with each other in the storage unit 21. Therefore, after the execution of the job starts, the job management apparatuses 11 and 12 are able to obtain the execution status of the job using only the identification information IDa without being aware of the identification information IDb. Even when a failover is performed between the job management apparatuses, the job management apparatus 12 that has transitioned to the active system is able to obtain the execution status of the job using only the identification information IDa and take over the management process for the job. Thus, it is possible to achieve reliable failover between the job management apparatuses.

### Second Embodiment

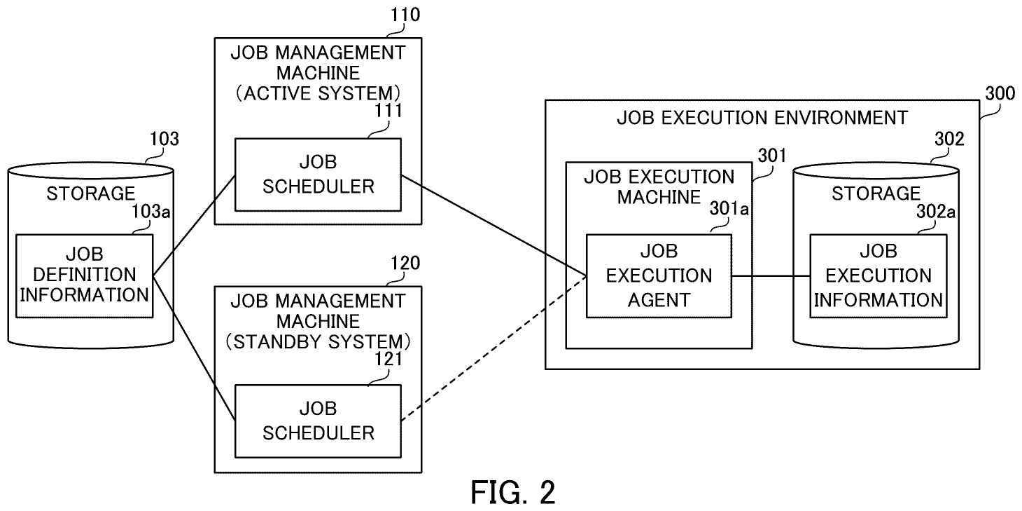

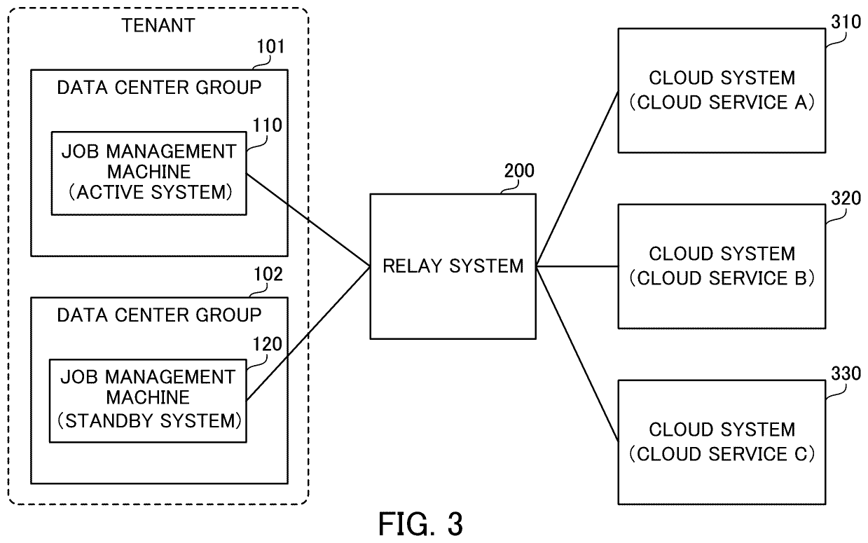

The following describes a job management system according to a second embodiment. In the following description, a comparative example of the job management system will be described first with reference to FIG. 2, and the job management system according to the second embodiment will be described with reference to FIG. 3 and subsequent drawings.

FIG. 2 illustrates a job management system according to a comparative example. The job management system illustrated in FIG. 2 includes job management machines 110 and 120 configured redundantly and a job execution machine 301.

The job management machines 110 and 120 are devices that manage execution of jobs in the job execution machine 301. The job management machines 110 and 120 may be physical machines such as server computers, or may be virtual machines. The job management machines 110 and 120 include job schedulers 111 and 121, respectively.

One of the job management machines 110 and 120 operates as an active system, and the other operates as a standby system. When the job management machine as the active system stops its operation, a failover occurs to cause the job management machine operating as the standby system to transition to the active system. The job management machine newly as the active system takes over an execution management process for jobs. Note that, in order to improve the availability, the job management machines 110 and 120 are preferably implemented as physical machines or virtual machines in different data centers or different data center groups, for example.

The job management machines 110 and 120 are connected to a commonly accessible storage 103. The storage 103 stores job definition information 103a defining jobs to be executed. The job schedulers 111 and 121 of the job management machines 110 and 120 schedule jobs to be executed by the job execution machine 301 based on the job definition information 103a, and control the execution of the jobs in the job execution machine 301.

In practice, the storage 103 may be provided individually for each of the job management machines 110 and 120. For example, a storage provided in the same data center or data center group as the job management machine 110 and a storage provided in the same data center or data center group as the job management machine 120 may be used. The same job definition information 103a only needs to be stored in these storages.

The job execution machine 301 is a physical machine or a virtual machine configured in a predetermined job execution environment 300, and executes jobs in accordance with instructions from the outside. In the example of FIG. 2, the job execution machine 301 includes a job execution agent 301a that receives requests from the job schedulers 111 and 121 and causes the job execution machine 301 to execute jobs.

In the above-described job management system, requests relating to jobs are transmitted from the job schedulers 111 and 121 to the job execution agent 301a, and responses are returned from the job execution agent 301a. By deploying the job execution agent 301a on the job execution machine 301, it becomes possible to perform communication between the job schedulers 111 and 121 and the job execution agent 301a in a manner unique to the job execution requesting side, regardless of the job execution environment 300.

Hereinafter, the operation of the job management system illustrated in FIG. 2 will be described using an example in which the job management machine 110 operates as the active system. On the basis of the job definition information 103a, the job scheduler 111 of the job management machine 110 as the active system transmits an execution request requesting the start of execution of a job to the job execution agent 301a of the job execution machine 301. The job execution agent 301a causes the job execution machine 301 to execute the job corresponding to the request. At the same time, the job execution agent 301a generates job execution information 302a and stores it in a storage 302 included in the job execution environment 300. The job execution information 302a includes, for example, a job status indicating the execution status of the job and others, and is stored in the storage 302 in a format associated with the identification information of the job specified by the job execution requesting side.

The job execution agent 301a monitors the execution status of the job that has started execution, and updates the job status of the job execution information 302a according to the monitoring result. Meanwhile, after the execution of the job starts, the job scheduler 111 periodically transmits, to the job execution agent 301a, a request to obtain the job status of the job. When the job scheduler 111 determines based on the job status returned from the job execution agent 301a that the execution of the job is complete, the job scheduler 111 transmits an execution request requesting the start of execution of the next job to the job execution agent 301a.

Here, when the job management machine 110 abnormally stops, the job management machine 120 transitions from the standby system to the active system. The job scheduler 121 of the job management machine 120 transmits, to the job execution agent 301a, a request to obtain the job status of the job that has not yet completed execution. The job execution agent 301a returns the job status of the job to the job scheduler 121 based on the job execution information 302a stored in the storage 302. When the job scheduler 121 determines based on the job status that the execution of the job is not complete, the job scheduler 121 periodically transmits a request to obtain the job status as described above, to continue the execution management process for the job.

As described above, the job execution agent 301a stores the job execution information 302a in the format associated with the identification information of the corresponding job specified by the job execution requesting side. As a result, even when a failover occurs between the job management machines, the job scheduler of the job management machine that has newly transitioned to the active system is able to take over the execution management process for a job that has not yet completed execution.

However, in the case of causing a system (cloud system) provided by a cloud service to execute a job, a device corresponding to the job execution machine 301 is managed by the provider of the cloud system. For this reason, in general, the job execution requesting side that is a user of the cloud system is unable to deploy the job execution agent 301a on the cloud system. For example, when executing a new job, the cloud system generates job execution information in a format determined by the cloud service side. Therefore, the job execution requesting side is unable to associate the generated job execution information with the identification information (job ID) of the job specified by the job execution requesting side. As a result, when a failover to a job management machine occurs, the job management machine is not able to take over an execution management process for a job that has not yet completed execution.

Specifically, the job execution information generated by the cloud system includes the identification information (execution ID) of a job for the cloud system to identify the job. In the case where the job execution requesting side is not able to deploy the job execution agent 301a, the job execution requesting side is not able to associate the generated execution ID with the job ID specified by the job execution requesting side. Therefore, when a failover occurs, the job scheduler of the job management machine that has newly transitioned to the active system is unable to recognize the execution ID of the job to be monitored and is thus unable to take over the execution management process for the job.

As described above, in the case of causing the cloud system to execute a job, it is not possible to deploy the job execution agent 301a. In this case, a problem to be addressed is how to manage information needed for taking over an execution management process for a job and how to enable a job management machine to acquire the information after a failover.

Here, in recent years, in order to grow business and enhance competitiveness, data-driven business in which business decisions are made by gaining insights from data using digital technologies has been attracting attention. In order to maintain a competitive advantage in such data-driven business, it is needed to configure an infrastructure for fast data utilization on cloud services. From this background, high availability is needed for the execution of business jobs on cloud services.

In addition, jobs are often executed across a plurality of cloud services in combination, which increases the need for job execution management across the plurality of cloud services. Further, as a business system becomes more complex due to the cooperation with the plurality of cloud services, the time needed for recovery when an abnormality occurs increases. Therefore, high availability is needed to reduce an operational load.

FIG. 3 illustrates an example of a configuration of a job management system according to the second embodiment. The job management system illustrated in FIG. 3 is a system that executes jobs across one or more cloud services, and includes job management machines 110 and 120 configured redundantly, a relay system 200, and cloud systems 310, 320, and 330.

The job management machines 110 and 120 are examples of the job management apparatuses 11 and 12 in FIG. 1. The relay system 200 is an example of the relay system 20 of FIG. 1. The cloud systems 310, 320, and 330 are examples of the job execution system 30 of FIG. 1.

The job management machines 110 and 120 are devices that manage the execution of jobs in the cloud systems 310, 320, and 330. One of the job management machines 110 and 120 operates as an active system, and the other operates as a standby system. When the job management machine as the active system stops its operation, a failover occurs to cause the job management machine as the standby system to transition to the active system. The job management machine newly as the active system takes over an execution management process for jobs. In the following description, it is assumed that the job management machine 110 operates as the active system and the job management machine 120 operates as the standby system in the initial state.

The job management machines 110 and 120 are, for example, physical machines or virtual machines provided by a cloud service. In this case, the job management machine 110 is a physical machine or a virtual machine implemented in a data center group 101, and the job management machine 120 is a physical machine or a virtual machine implemented in a data center group 102 different from the data center group 101. The data center groups 101 and 102 are management units of data centers in the cloud service, and are, for example, availability zones in Amazon web service (AWS, registered trademark). The job management machines 110 and 120 belong to the same tenant. That is, the job management machines 110 and 120 are provided under the same cloud service contract with a user.

The cloud systems 310, 320, and 330 are computer systems that implement individual cloud services A, B, and C, respectively. Each of the cloud systems 310, 320, and 330 has a job execution function, and performs job-related processes in response to requests received via, for example, a representational state transfer application programming interface (REST API). In this connection, the job management system of FIG. 3 includes the three cloud systems 310, 320, and 330 as an example, but the job management system may include one or more cloud systems having a job execution function.

The relay system 200 is a computer system including one or more physical machines. The relay system 200 relays communication between the job management machines 110 and 120 and the cloud systems 310, 320, and 330.

Here, a hardware configuration of a physical machine included in the relay system 200 will be described.

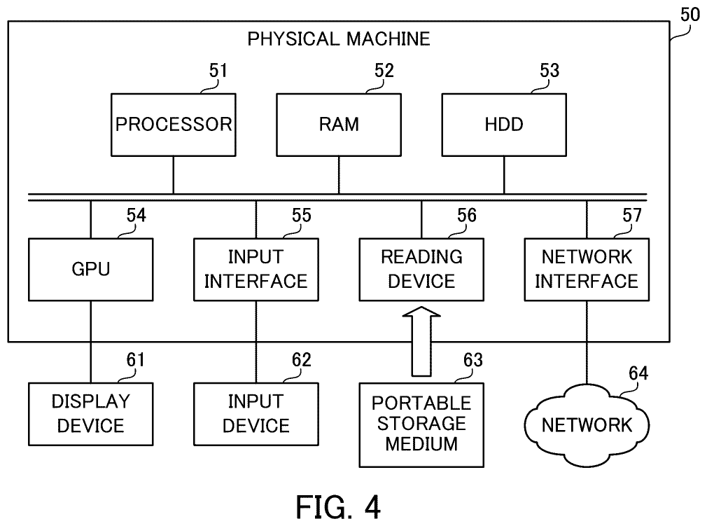

FIG. 4 illustrates a hardware configuration of a physical machine. The physical machine 50 is implemented as, for example, a computer as illustrated in FIG. 4. The physical machine 50 illustrated in FIG. 4 includes a processor 51, a random access memory (RAM) 52, a hard disk drive (HDD) 53, a graphics processing unit (GPU) 54, an input interface 55, a reading device 56, and a network interface 57.

The processor 51 comprehensively controls the entire physical machine 50. The processor 51 is, for example, a central processing unit (CPU), a micro processing unit (MPU), a digital signal processor (DSP), an application specific integrated circuit (ASIC), or a programmable logic device (PLD). The processor 51 may be a combination of two or more selected from a CPU, an MPU, a DSP, an ASIC, and a PLD. The physical machine 50 may include a plurality of processors 51. A processor that executes a certain process among a plurality of processes that the physical machine 50 executes may be different from a processor that executes a process different from the certain process. The processor 51 may be referred to as processor circuitry.

The RAM 52 is used as a main storage device of the physical machine 50. The RAM 52 temporarily stores at least part of an operating system (OS) program and application programs to be executed by the processor 51. The RAM 52 also stores various data needed for the processing of the processor 51.

The HDD 53 is used as an auxiliary storage device of the physical machine 50. The HDD 53 stores the OS program, application programs, and various data. As the auxiliary storage device, another type of non-volatile storage device such as a solid state drive (SSD) may be used.

A display device 61 is connected to the GPU 54. The GPU 54 displays images on the display device 61 in accordance with instructions from the processor 51. Examples of the display device 61 include a liquid crystal display and an organic electroluminescence (EL) display.

An input device 62 is connected to the input interface 55. The input interface 55 transmits signals output from the input device 62 to the processor 51. Examples of the input device 62 include a keyboard and a pointing device. Pointing devices include mouses, touch panels, tablets, touch pads, and track balls.

A portable storage medium 63 is attached to and detached from the reading device 56. The reading device 56 reads data recorded on the portable storage medium 63 and transmits the data to the processor 51. Examples of the portable storage medium 63 include an optical disc and a semiconductor memory.

The network interface 57 transmits and receives data to and from other devices via a network 64.

With the hardware configuration described above, the processing functions of the physical machine 50 included in the relay system 200 are implemented. Each physical machine included in the data center groups 101 and 102 and the cloud systems 310, 320, and 330 may also have the same hardware configuration as in FIG. 4.

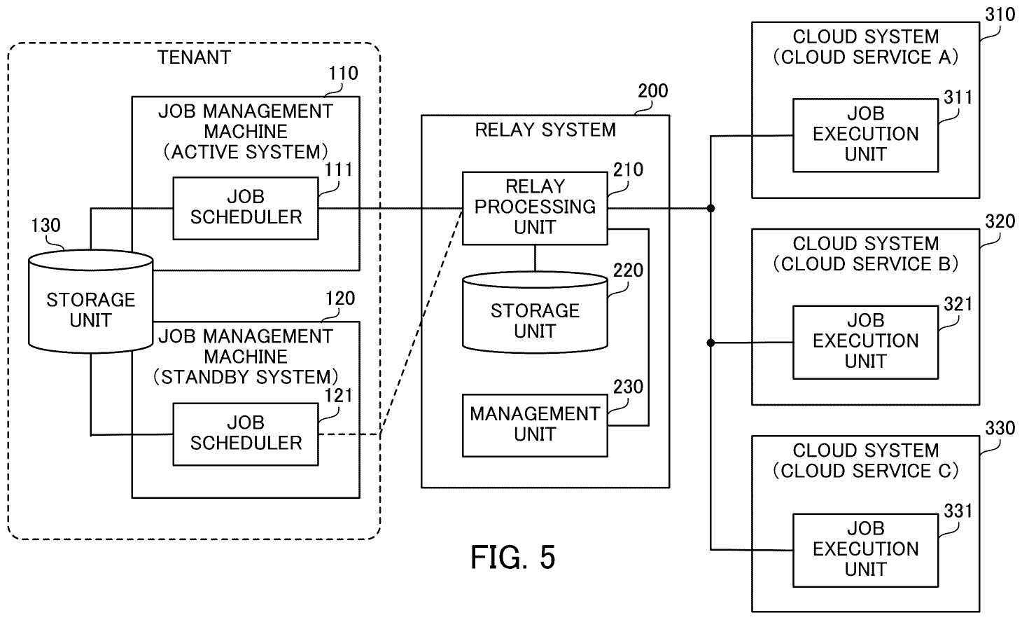

FIG. 5 illustrates an example of a configuration of processing functions provided in the job management system.

The job management machines 110 and 120 include the job schedulers 111 and 121, respectively. The processes of the job scheduler 111 are implemented, for example, by the processor of the job management machine 110 executing predetermined programs. Similarly, the processes of the job scheduler 121 are implemented, for example, by the processor of the job management machine 120 executing predetermined programs.

The job management machines 110 and 120 are connected to a commonly accessible storage unit 130. The storage unit 130 is a storage area allocated in a non-volatile storage device. In practice, for example, a storage area in a storage device provided in the data center group 101 and a storage area in a storage device provided in the data center group 102 are allocated for the storage unit 130, and data may be mirrored between these storage areas.

The storage unit 130 stores job definition information and a job management table. The job definition information includes various parameters relating to jobs to be executed by the cloud systems 310, 320, and 330. The job management table is generated for each job requested for execution, and includes a job ID, a job status, and others. The job schedulers 111 and 121 schedule the jobs to be executed, on the basis of the job definition information, and transmit execution requests and monitoring requests for the jobs to the relay system 200.

The cloud systems 310, 320, and 330 include job execution units 311, 321, and 331, respectively. The processes of the job execution unit 311 are implemented by, for example, the processor of a physical machine included in the cloud system 310 executing predetermined programs. Similarly, the processes of the job execution unit 321 are implemented by, for example, the processor of a physical machine included in the cloud system 320 executing predetermined programs. The processes of the job execution unit 331 are implemented by, for example, the processor of a physical machine included in the cloud system 330 executing predetermined programs. The job execution units 311, 321, and 331 execute jobs in response to requests from the relay system 200 and return information indicating execution statuses and execution results.

The relay system 200 includes a relay processing unit 210, a storage unit 220, and a management unit 230. The processes of the relay processing unit 210 and the management unit 230 are implemented by, for example, the processor of a physical machine included in the relay system 200 executing predetermined programs. Alternatively, the processes of the relay processing unit 210 and the management unit 230 may be implemented by the processors of different physical machines included in the relay system 200. The storage unit 220 is a storage area allocated in a non-volatile storage device included in the relay system 200.

When the relay processing unit 210 receives an execution request for a job from one of the job schedulers 111 and 121, the relay processing unit 210 transfers the execution request to a cloud system (any one of the cloud systems 310, 320, and 330) responsible for the job execution and to cause the cloud system to start the execution of the job. At this time, the relay processing unit 210 acquires the identification information (execution ID) of the job assigned to the job from the cloud system responsible for the job execution. Then, the relay processing unit 210 registers a new record in which the acquired execution ID is associated with the job ID specified by the job scheduler 111 or 121, in a relay job management table in the storage unit 220.

Once the execution of the job starts in the cloud system, the relay processing unit 210 periodically acquires a job status indicating the execution status of the job from the cloud system responsible for the job execution until the execution of the job is complete, and registers the job status in the relay job management table. For this status acquisition, the relay processing unit 210 specifies the execution ID of the job to be monitored. Meanwhile, the job scheduler 111 or 121 periodically transmits, to the relay processing unit 210, a request specifying the job ID of the job to obtain the job status. In response to the request, the relay processing unit 210 returns the job status registered in the relay job management table to the job scheduler 111 or 121. This monitoring process for the job continues until the job status indicates completion of the job.

In the above processes of the relay processing unit 210, the job ID specified by the job scheduler 111 or 121 and the execution ID assigned by the cloud system responsible for the job execution are managed in association with each other. Therefore, the job schedulers 111 and 121 are able to obtain the execution statuses of jobs by specifying the job IDs of the jobs to the relay processing unit 210. With this configuration, it is possible to achieve a failover between the job management machines 110 and 120 easily and reliably, as will be described later.

The management unit 230 manages the operation of the relay processing unit 210. For example, a plurality of relay processing units 210 may be activated according to the number of jobs requested for execution by the job schedulers 111 and 121. The management unit 230 generates (activates) or deletes relay processing units 210 according to the number of jobs.

Relay processing units 210 are implemented in a virtual execution environment configured within the relay system 200. This makes it possible to easily generate or delete the relay processing units 210, compared to the case where a plurality of relay processing units 210 are implemented as separate physical machines or virtual machines.

For example, each relay processing unit 210 is implemented as a container. The container virtualization is a technique that configures isolated execution environments for individual applications on a virtualized OS. Each container is a separate virtual user space in the OS execution environment. Each user space is provided as a separate resource group for application execution. For example, an individual memory space is allocated to a container. In the case where each relay processing unit 210 is implemented as a container, the processes of the management unit 230 are implemented by management software that manages the containers. Since the generation (activation) of a container corresponds to the activation of a process on the OS, it is faster than the activation of a hypervisor-based virtual machine.

Alternatively, each relay processing unit 210 may be implemented by executing a program called a serverless function. The execution of the serverless function provides a serverless environment in which a program is executable without configuring a physical server.

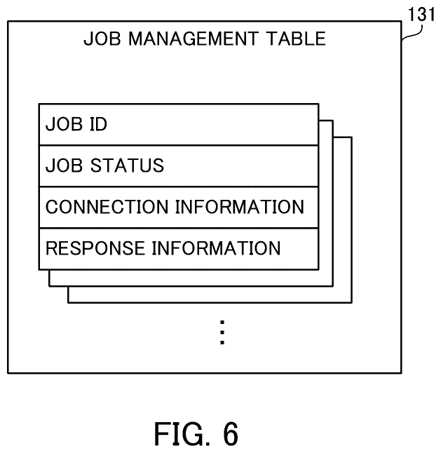

The following describes the job management table stored in the storage unit 130 on the job execution requesting side. FIG. 6 illustrates an example of a data structure of the job management table.

A record is registered in the job management table 131 for each job requested for execution by the job schedulers 111 and 121. Each record includes the following fields: job ID, job status, connection information, and response information.

The job ID is identification information assigned by the job execution requesting side to a job requested for execution. The job status is information indicating the execution status of the job. For example, the job status is any one of “waiting for execution” indicating that the job is waiting for execution, “in progress” indicating that the job is in progress, “normal termination” indicating that the job has completed successfully, “abnormal termination” indicating that the job has ended abnormally, and “forced termination” indicating that the job has been forcibly terminated.

The connection information is information for connecting to a cloud system for job execution. For example, the connection information includes execution request information, monitoring request information, and forced termination request information with respect to the job.

The execution request information is information relating to an execution request for starting the execution of the job. The execution request information includes, for example, the uniform resource locator (URL) of a cloud system that is a connection destination, the name of a hypertext transfer protocol (HTTP) method, authentication information, and an HTTP request header.

The monitoring request information is information relating to a monitoring request to obtain a job status. The monitoring request information includes the URL of the cloud system that is a connection destination, the name of an HTTP method, an HTTP request header, the number of polling times and a polling interval for making the monitoring request, a monitoring completion condition, and a determination condition of normal termination. In this connection, the monitoring request information is registered in the record only in the case where the job requested for execution is a job that needs polling for the monitoring request after the transmission of the request. The monitoring request information is execution transmitted to the relay processing unit 210 together with the execution request.

The forced termination request information is information relating to a forced termination request to forcibly terminate the job. The forced termination request information includes, for example, the URL of the cloud system that is a connection destination and the name of an HTTP method.

The response information is information included in a response returned from the cloud system in response to a request, and is obtained from the relay processing unit 210. The response information includes an execution ID assigned by the cloud system, and a job status indicating the execution status of the job, returned from the cloud system.

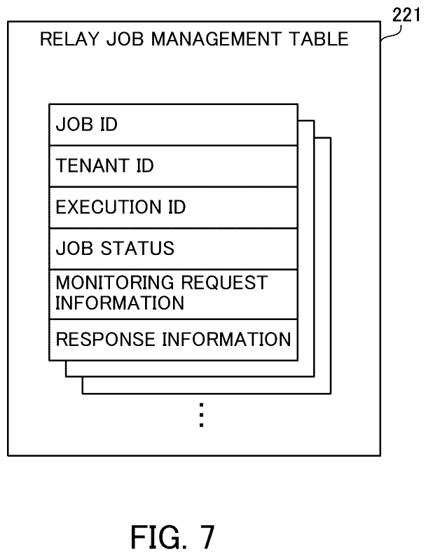

The following describes the relay job management table stored in the storage unit 220 of the relay system 200. FIG. 7 illustrates an example of a data structure of the relay job management table.

A record is registered in the relay job management table 221 for each job requested for execution by the job schedulers 111 and 121. Each record includes the following fields: job ID, tenant ID, execution ID, job status, monitoring request information, and response information.

The job ID is identification information assigned to a job by the job execution requesting side. The tenant ID is the identification information of a tenant on the job execution requesting side. The job ID is assigned by the tenant side. Therefore, when jobs are requested from a plurality of tenants, each of the jobs is identified using a combination of the job ID and the tenant ID.

The execution ID is identification information assigned by the cloud system to the job executed in response to an execution request. As described above, the relay job management table 221 manages the job ID and the tenant ID, which are used by the tenant side to identify the job, in association with the execution ID, which is used by the cloud system side to identify the job.

The job status is information indicating the execution status of the job. The job status is referenced by the job execution requesting side. For example, the job status is any one of “waiting for execution”, “in progress”, “normal termination”, “abnormal termination”, and “forced termination” described above.

The monitoring request information is information relating to a monitoring request. The monitoring request information is transmitted from job scheduler 111 or 121 together with an execution request for starting the execution of the job, and is registered in the record of the relay job management table 221.

The response information is information included in a response returned from the cloud system in response to a request. The response information includes an execution ID and a job status. For example, the job status is any one of “in progress” indicating that the job is in progress, “normal termination” indicating that the job has completed successfully, and “abnormal termination” indicating that the job has ended abnormally.

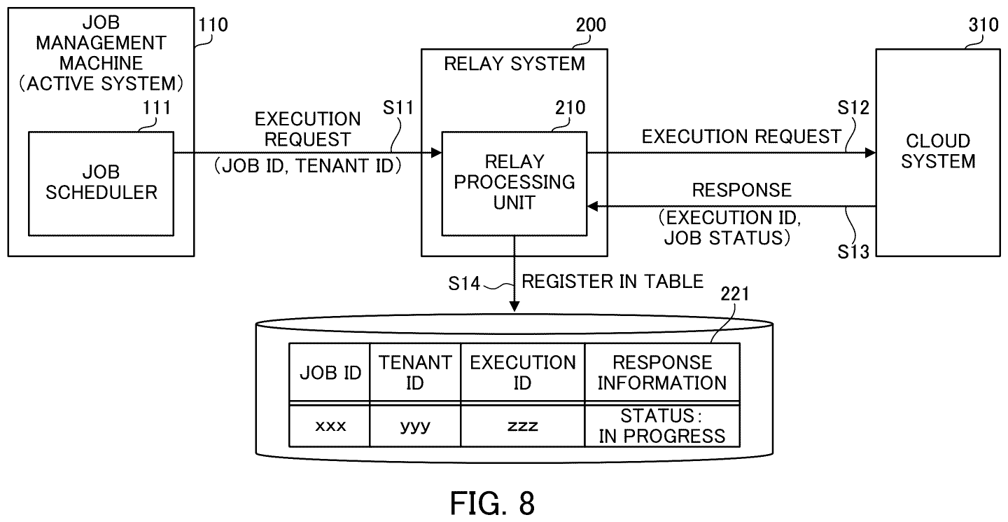

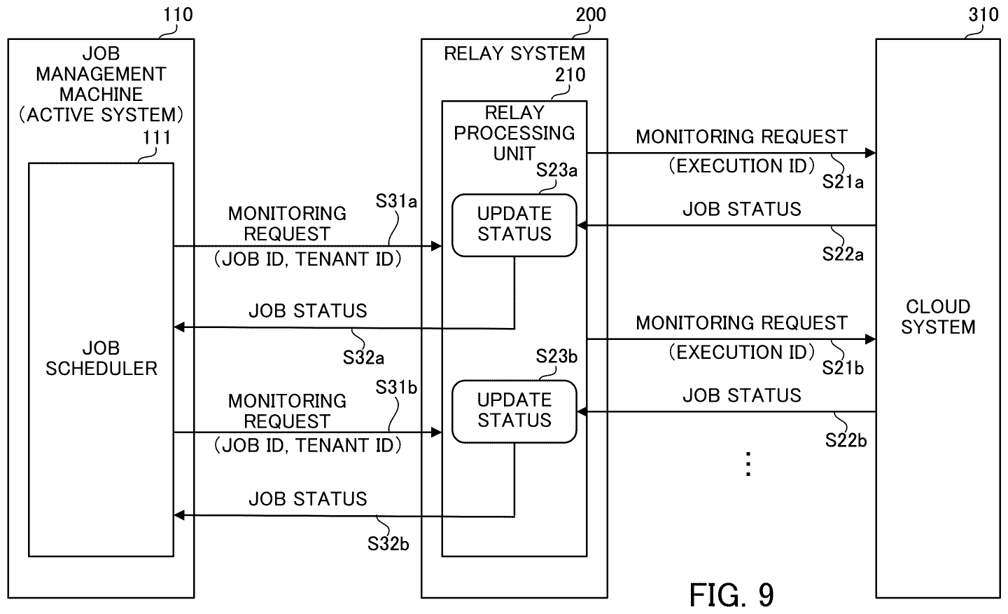

Next, the operations of the job management system when a job is executed and when a failover occurs during the execution of a job will be described with reference to FIGS. 8 to 10. In FIGS. 8 and 9, it is assumed that the job management machine 110 operates as an active system and the job management machine 120 operates as a standby system. In the following description, it is also assumed that the cloud system 310 is caused to execute a job, as an example.

First, FIG. 8 illustrates an example of operations that are performed at the start of execution of a job. The job scheduler 111 of the job management machine 110 transmits an execution request to the relay processing unit 210 to cause the cloud system 310 to start the execution of the job (step S11). At this time, the job scheduler 111 sets the job ID assigned to the job to be executed and the tenant ID in the execution request. The job scheduler 111 adds a new record to the job management table 131 and registers the job ID in the record.

The relay processing unit 210 transfers the execution request to the cloud system 310 to request the start of execution of the job (step S12). The job execution unit 311 of the cloud system 310 starts to execute the job, assigns an execution ID to the job, and returns a response including the execution ID and a job status indicating “in progress” to the relay processing unit 210 (step S13).

The relay processing unit 210 adds a new record to the relay job management table 221, and registers the job ID, the tenant ID, the execution ID, and response information in the record (step S14). The response information includes the job status included in the response returned in step S13. In practice, the relay processing unit 210 may add the record to the relay job management table 221 and register the job ID and the tenant ID when receiving the execution request.

Thereafter, the job is monitored as illustrated in FIG. 9. FIG. 9 illustrates an example of operations that are performed during the execution of the job.

After transmitting the execution request for the job, the relay processing unit 210 polls the cloud system 310 responsible for the job execution for a monitoring request to obtain the job status. In this monitoring request, the job to be monitored is specified by setting the execution ID.

In the example of FIG. 9, the relay processing unit 210 transmits a monitoring request specifying the execution ID to the cloud system 310 (step S21a). In the case where the job is being executed, the job execution unit 311 of the cloud system 310 returns a response including a job status indicating “in progress” to the relay processing unit 210 (step S22a). The relay processing unit 210 then updates the job status of the corresponding record in the relay job management table 221 based on the job status included in the response (step S23a).

Here, in the case where the job status is “in progress”, the relay processing unit 210 transmits a monitoring request specifying the execution ID to the cloud system 310 after a certain period of time (step S21b). If the job is being executed, the job execution unit 311 of the cloud system 310 returns a response including a job status indicating “in progress” to the relay processing unit 210 (step S22b). The relay processing unit 210 then updates the job status of the corresponding record in the relay job management table 221 based on the job status included in the response (step S23b).

In this way, the relay processing unit 210 continues polling the cloud system 310 for the monitoring request until the job status is updated to either “normal termination” or “abnormal termination”.

Meanwhile, after transmitting the execution request for the job, the job scheduler 111 also polls the relay processing unit 210 for a monitoring request to obtain a job status. In this monitoring request job, the job to be monitored is specified by setting the job ID and the tenant ID.

In the example of FIG. 9, the job scheduler 111 transmits a monitoring request having the job ID and the tenant ID set therein, to the relay processing unit 210 (step S31a). The relay processing unit 210 detects the record including the set job ID and tenant ID from the relay job management table 221, and returns the job status registered in the detected record to the job scheduler 111 (step S32a).

In the case where the job status is “in progress”, the job scheduler 111 transmits a monitoring request having the job ID and the tenant ID set therein, to the relay processing unit 210 after a certain period of time (step S31b). The relay processing unit 210 detects the record including the set job ID and tenant ID from the relay job management table 221, and returns the job status registered in the detected record to the job scheduler 111 (step S32b).

In this way, the job scheduler 111 continues polling the relay processing unit 210 for a monitoring request until the job status is updated to either “normal termination” or “abnormal termination”. When the job status is updated to either “normal termination” or “abnormal termination”, the job scheduler 111 completes the monitoring process for the job.

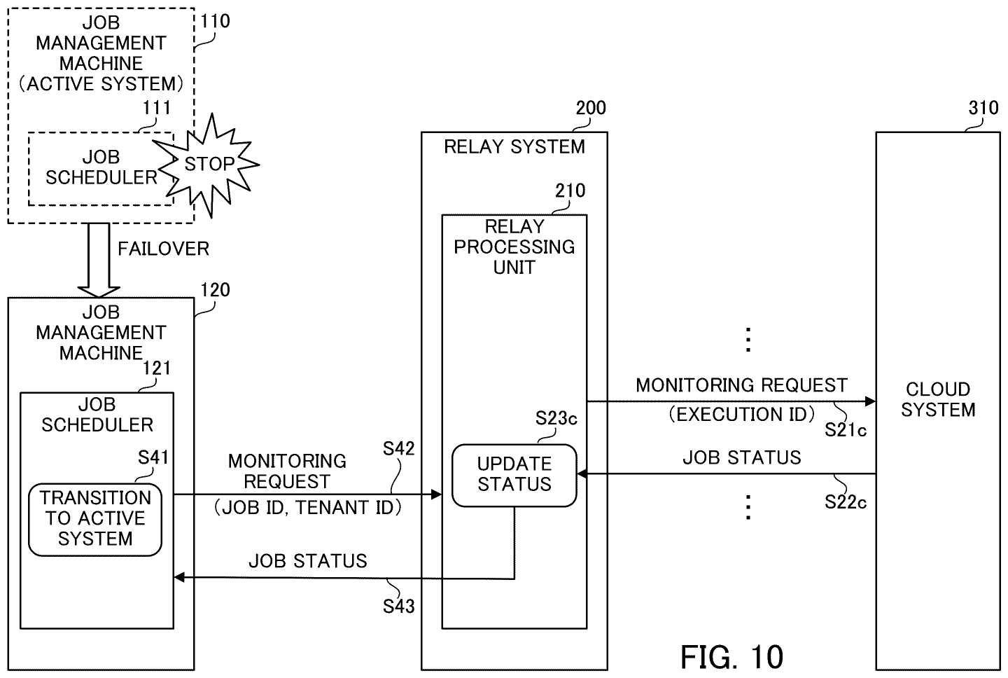

The following describes a failover process that is performed when the job management machine 110 abnormally stops while the job scheduler 111 performs a monitoring process for a job. FIG. 10 illustrates an example of operations that are performed at the time of failover.

The relay processing unit 210 continues the monitoring process for the job illustrated in FIG. 9. In the example of FIG. 10, the relay processing unit 210 transmits a monitoring request specifying the execution ID to the cloud system 310 (step S21c). The job execution unit 311 of the cloud system 310 returns a response including the job status to the relay processing unit 210 (step S22c). The relay processing unit 210 updates the job status of the corresponding record in the relay job management table 221 based on the job status included in the response (step S23c).

Meanwhile, when the job management machine 120 detects that the job management machine 110 has abnormally stopped, the job management machine 120 transitions from the standby system to the active system (step S41). The job scheduler 121 of the job management machine 120 obtains the job ID of the job in progress from the job management table 131, and transmits a monitoring request having the job ID and the tenant ID set therein, to the relay processing unit 210 (step S42). The relay processing unit 210 detects the record including the set job ID and tenant ID from the relay job management table 221, and returns the job status registered in the detected record to the job scheduler 121 (step S43).

As a result, the job scheduler 121 is able to recognize the execution status of the job and perform an appropriate process for the status. For example, in the case where the job status is “in progress”, the job scheduler 121 polls the relay processing unit 210 for a monitoring request until the job status is updated to either “normal termination” or “abnormal termination”. That is, the job scheduler 121 is able to take over the monitoring process for the job in progress from the job scheduler 111.

As described above, in the present embodiment, the storage unit 220 of the relay system 200 stores the job ID and the tenant ID, which are used by the tenant side to identify the job, in association with the execution ID, which is used by the cloud system side to identify the job. This ensures that information needed for the job management machine that has been activated by failover to take over the monitoring process for jobs is held in the storage unit 220 of the relay system 200. Therefore, the job scheduler of the job management machine that has been activated by failover is able to acquire the job status using the job ID assigned by the job execution requesting side as it is, without using the execution ID assigned by the cloud system responsible for the job execution. Thus, the job scheduler of the job management machine that has been activated by failover is able to easily and reliably take over the monitoring process for the job in progress.

The following describes the processes of the job schedulers 111 and 121 and the relay processing unit 210 with reference to flowcharts.

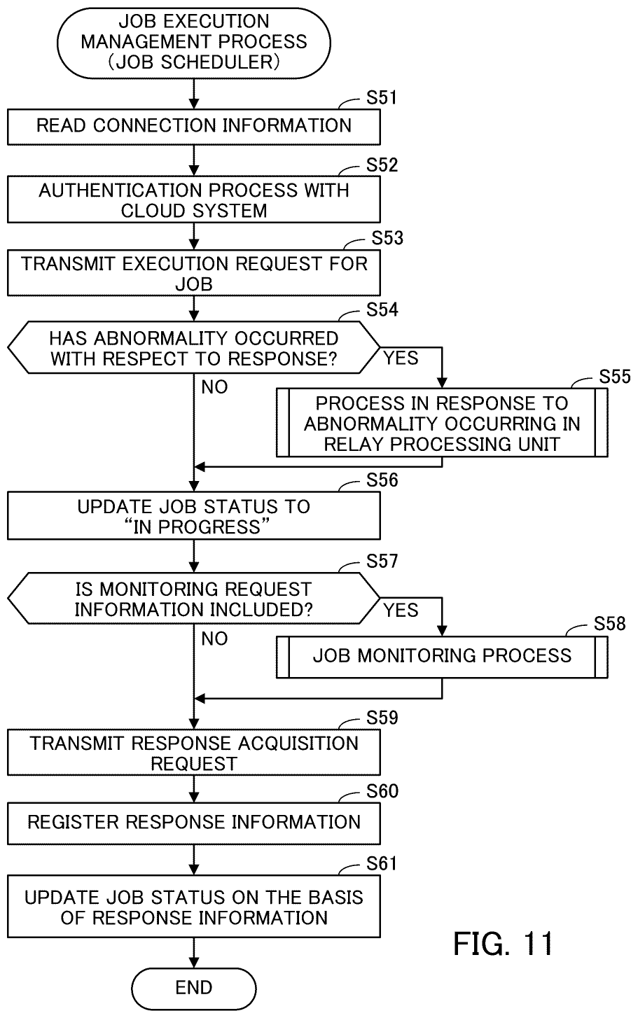

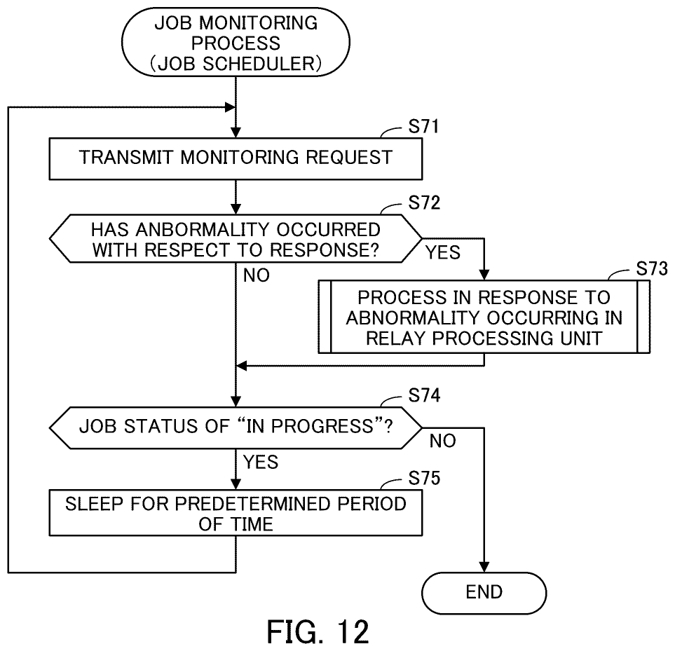

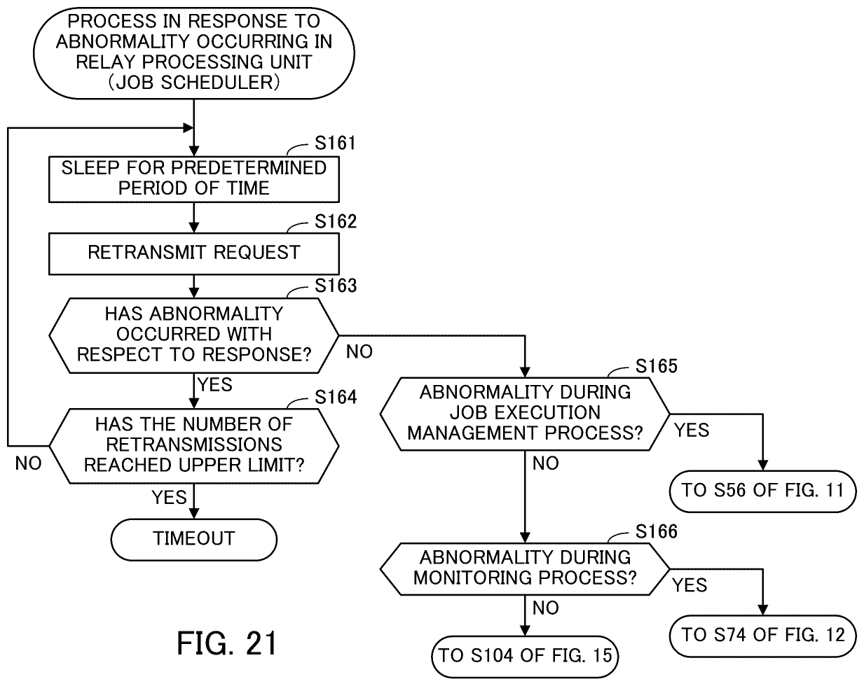

FIG. 11 is a flowchart illustrating an example of a job execution management process performed by the job scheduler. The process of FIG. 11 is performed when the job scheduler 111 of the job management machine 110 as the active system causes a cloud system responsible for job execution to start execution of a new job. Here, it is assumed that the cloud system 310 is caused to execute the job.

[Step S51] The job scheduler 111 adds a new record to the job management table 131, assigns a job ID to the job to be executed, and registers the job ID in the added record. In addition, the job scheduler 111 obtains connection information for job execution management from the job definition information, and registers the connection information in the connection information field of the added record. Further, the job scheduler 111 registers “waiting for execution” in the job status field of the added record. Then, the job scheduler 111 reads the connection information.

[Step S52] The job scheduler 111 performs an authentication process with the cloud system 310 using the authentication information included in the read connection information. If the authentication process is successful, the process proceeds to step S53.

[Step S53] The job scheduler 111 transmits an execution request to the relay processing unit 210 to cause the cloud system 310 to start the execution of the job. In the execution request to be transmitted, the job ID, the tenant ID, and the connection information are set.

[Step S54] The job scheduler 111 determines whether an abnormality has occurred with respect to a response that is returned from the relay processing unit 210 in response to the execution request. For example, if no response is transmitted from the relay processing unit 210 or if the response returned indicates an abnormality, the job scheduler 111 determines that an abnormality has occurred, and the process proceeds to step S55. On the other hand, if a response is transmitted properly from the relay processing unit 210, the process proceeds to step S56.

[Step S55] The job scheduler 111 performs a process in response to an abnormality occurring in the relay processing unit 210. This process includes retransmitting the execution request. The details of the process in step S55 will be described later with reference to FIG. 21.

[Step S56] The job scheduler 111 updates the job status of the record added to the job management table 131 in step S51 to “in progress”.

[Step S57] The job scheduler 111 determines whether the connection information includes monitoring request information. If the monitoring request information is included, the process proceeds to step S58. If the monitoring request information is not included, the process proceeds to step S59.

[Step S58] The job scheduler 111 performs a job monitoring process by polling for a monitoring request to obtain a job status. The details of the process in step S58 will be described later with reference to FIG. 12.

[Step S59] The job scheduler 111 transmits a response acquisition request to the relay processing unit 210 to obtain response information. In the response acquisition request to be transmitted, the same job ID and tenant ID as used in step S53 are set.

The relay processing unit 210 that has received the response acquisition request detects the record including the job ID and the tenant ID from the relay job management table 221, extracts response information from the detected record, and returns the response information to the job scheduler 111.

[Step S60] The job scheduler 111 registers response information returned from the relay processing unit 210, in the response information field of the record added to the job management table 131 in step S51.

[Step S61] The job scheduler 111 updates the job status of the record added to the job management table 131 in step S51, to “normal termination” or “abnormal termination” on the basis of the job status included in the response information.

FIG. 12 is a flowchart illustrating an example of a job monitoring process performed by the job scheduler. The process of FIG. 12 corresponds to the process of step S58 of FIG. 11.

[Step S71] The job scheduler 111 transmits a monitoring request to the relay processing unit 210 to obtain a job status. In the monitoring request to be transmitted, the job ID and the tenant ID are set.

[Step S72] The job scheduler 111 determines whether an abnormality has occurred with respect to a response that is returned from the relay processing unit 210 in response to the monitoring request. For example, if no response is transmitted from the relay processing unit 210 or if the response returned indicates an abnormality, the job scheduler 111 determines that an abnormality has occurred, and the process proceeds to step S73. On the other hand, if a response is transmitted properly from the relay processing unit 210, the process proceeds to step S74.

[Step S73] The job scheduler 111 performs a process in response to an abnormality occurring in the relay processing unit 210. This process includes retransmitting the monitoring request. The details of the process of step S73 will be described with reference to FIG. 21.

[Step S74] The job scheduler 111 determines whether the job status included in the response to the monitoring request is “in progress”. If the job status is “in progress”, the process proceeds to step S75. On the other hand, if the job status is “normal termination” or “abnormal termination”, the job scheduler 111 completes the job monitoring process, and the process proceeds to step S59 of FIG. 11.

[Step S75] The job scheduler 111 extracts the polling interval from the monitoring request information included in the connection information, and enters a sleep state for the period of time indicated by the polling interval. When this period of time has elapsed, the sleep state is canceled, and the process proceeds to step S71.

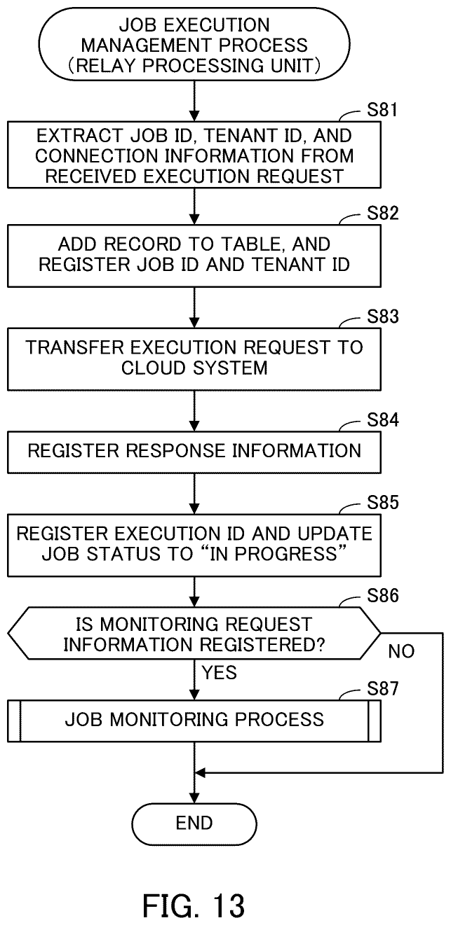

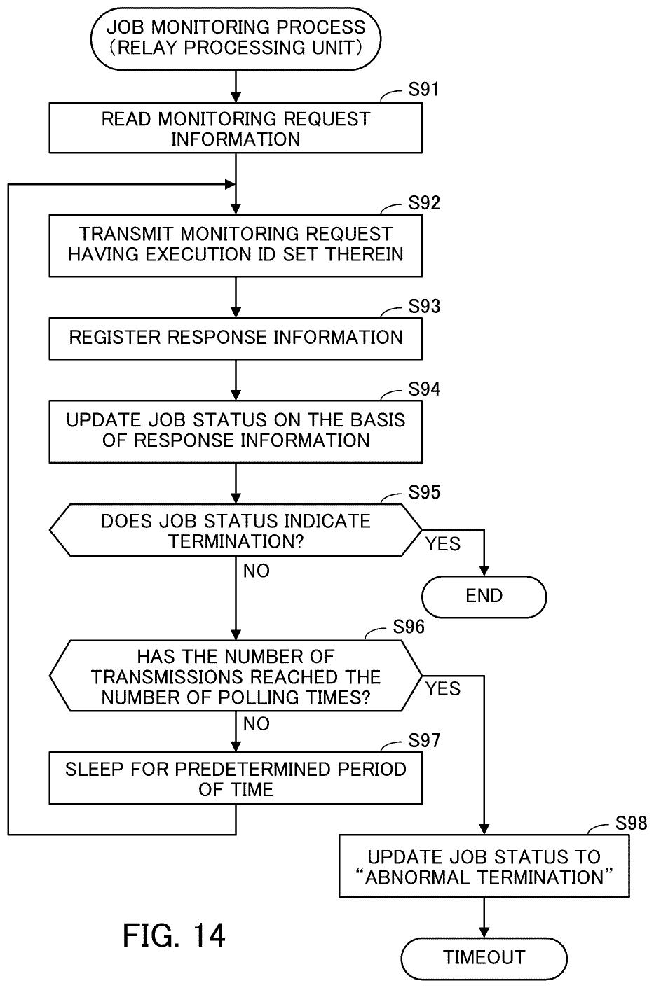

FIG. 13 is a flowchart illustrating an example of a job execution management process performed by a relay processing unit.

[Step S81] The relay processing unit 210 receives an execution request requesting the execution of a job from the job scheduler 111. Here, as an example, it is assumed that the relay processing unit 210 receives an execution request to cause the cloud system 310 to execute the job. This execution request is transmitted from the job scheduler 111 in step S53 of FIG. 11. The relay processing unit 210 extracts the job ID, the tenant ID, and the connection information from the received execution request.

[Step S82] The relay processing unit 210 adds a new record to the relay job management table 221, and registers the job ID and the tenant ID extracted in step S81 in the added record. In the case where the connection information extracted in step S81 includes monitoring request information, the relay processing unit 210 registers the monitoring request information in the added record. In addition, the relay processing unit 210 registers “waiting for execution” in the job status field of the added record.

[Step S83] The relay processing unit 210 transfers the received execution request to the cloud system 310 responsible for the job execution.

[Step S84] The relay processing unit 210 receives a response to the execution request from the cloud system 310, and registers information included in the response to the response information field of the added record.

[Step S85] The relay processing unit 210 extracts the execution ID from the response information, and registers the execution ID in the execution ID field of the added record. In addition, the relay processing unit 210 updates the job status of the added record to “in progress”.

[Step S86] The relay processing unit 210 determines whether monitoring request information is registered in the added record (whether the monitoring request information has been registered in step S82). If the monitoring request information is registered, the process proceeds to step S87. if the monitoring request information is not registered, the relay processing unit 210 completes the job execution management process.

[Step S87] The relay processing unit 210 performs a job monitoring process by polling for a monitoring request to obtain a job status. The details of the process in step S87 will be described with reference to FIG. 14.

FIG. 14 is a flowchart illustrating an example of a job monitoring process performed by the relay processing unit. The process of FIG. 14 corresponds to the process of step S87 of FIG. 13.

[Step S91] The relay processing unit 210 reads the monitoring request information from the record added to the relay job management table 221 in step S82 of FIG. 13.

[Step S92] The relay processing unit 210 transmits, based on the monitoring request information, a monitoring request to the cloud system 310 to obtain a job status. In the monitoring request to be transmitted, the execution ID registered in the added record is set.

[Step S93] The relay processing unit 210 receives a response to the monitoring request from the cloud system 310, and registers the information included in the response to the response information field of the added record.

[Step S94] The relay processing unit 210 extracts the job status from the response information, and updates the job status of the added record on the basis of the extracted job status.

[Step S95] The relay processing unit 210 determines whether the updated job status satisfies the monitoring completion condition included in the monitoring request information. If the job status is either “normal termination” or “abnormal termination”, it is determined that the monitoring completion condition is satisfied, and the relay processing unit 210 completes the job monitoring process. On the other hand, if the job status is “in progress”, it is determined that the monitoring completion condition is not satisfied, and the process proceeds to step S96.

[Step S96] The relay processing unit 210 extracts the number of polling times from the monitoring request information, and determines whether the number of executions of step S92 (the number of transmissions of the monitoring request) has reached the number of polling times. If the number of transmissions is less than the number of polling times, the process proceeds to step S97. If the number of transmissions has reached the number of polling times, the process proceeds to step S98.

[Step S97] The relay processing unit 210 extracts the polling interval from the monitoring request information, and enters a sleep state for the period of time indicated by the polling interval. When this period of time has elapsed, the sleep state is canceled, and the process proceeds to step S92.

[Step S98] This step relates to a case where the execution of the job has not completed even when the monitoring request is transmitted a predetermined number of times. In this case, the relay processing unit 210 stops the transmission of the monitoring request and updates the job status of the added record to “abnormal termination”.

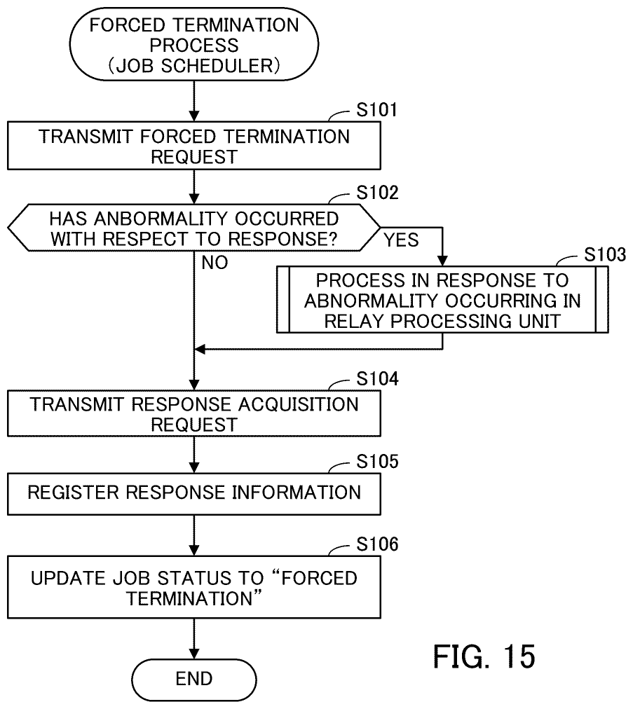

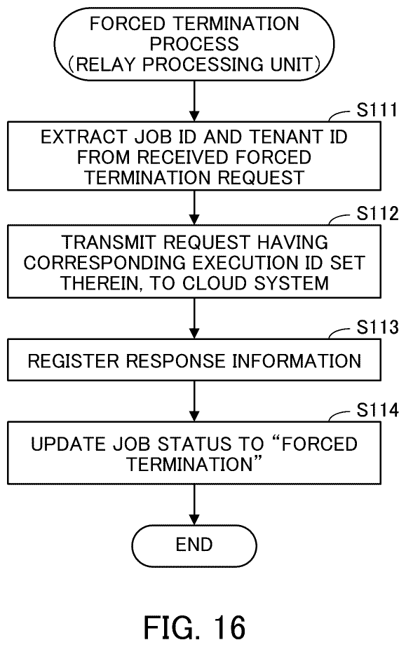

Next, a forced termination process for a job will be described with reference to FIGS. 15 and 16. The job scheduler 111 is able to request forced termination of a job at arbitrary timing during the period from when the job scheduler 111 requests the execution of the job to when the job scheduler 111 recognizes the completion of the execution.

FIG. 15 is a flowchart illustrating an example of a forced termination process performed by the job scheduler.

[Step S101] The job scheduler 111 transmits a forced termination request to the relay processing unit 210 to forcibly terminate a job in the cloud system 310. In the forced termination request to be transmitted, the job ID and the tenant ID are set to identify the job.

[Step S102] The job scheduler 111 determines whether an abnormality has occurred with respect to a response that is returned from the relay processing unit 210 in response to the forced termination request. For example, if no response is transmitted from the relay processing unit 210 or if the response returned indicates an abnormality, the job scheduler 111 determines that an abnormality has occurred, and the process proceeds to step S103. On the other hand, if a response is transmitted properly from the relay processing unit 210, the process proceeds to step S104.

[Step S103] The job scheduler 111 performs a process in response to an abnormality occurring in the relay processing unit 210. This process includes retransmitting the forced termination request. The details of the process of step S103 will be described with reference to FIG. 21.

[Step S104] The job scheduler 111 transmits a response acquisition request to the relay processing unit 210 to obtain response information. In the response acquisition request to be transmitted, the same job ID and tenant ID as used in step S101 are set.

[Step S105] The job scheduler 111 registers response information returned from the relay processing unit 210 in the response information field of the corresponding record in the job management table 131.

[Step S106] The job scheduler 111 updates the job status of the corresponding record in the job management table 131 to “forced termination”.

FIG. 16 is a flowchart illustrating an example of a forced termination process performed by the relay processing unit.

[Step S111] Upon receiving the forced termination request transmitted from the job scheduler 111 in step S101 of FIG. 15, the relay processing unit 210 extracts the job ID and the tenant ID from the forced termination request.

[Step S112] The relay processing unit 210 detects the record including the extracted job ID and tenant ID from the relay job management table 221. The relay processing unit 210 extracts the execution ID from the detected record and transmits a forced termination request having the extracted execution ID set therein, to the cloud system 310.

[Step S113] The relay processing unit 210 receives a response to the forced termination request from the cloud system 310, and registers the information included in the response in the response information field of the detected record.

[Step S114] The relay processing unit 210 updates the job status of the detected record to “forced termination”.

Although not illustrated, the relay processing unit 210 thereafter receives a response acquisition request transmitted from the job scheduler 111 in step S104 of FIG. 15. The relay processing unit 210 extracts the job ID and the tenant ID from the response acquisition request, and detects the record including the extracted job ID and tenant ID from the relay job management table 221. The relay processing unit 210 extracts response information from the detected record and returns the response information to the job scheduler 111.

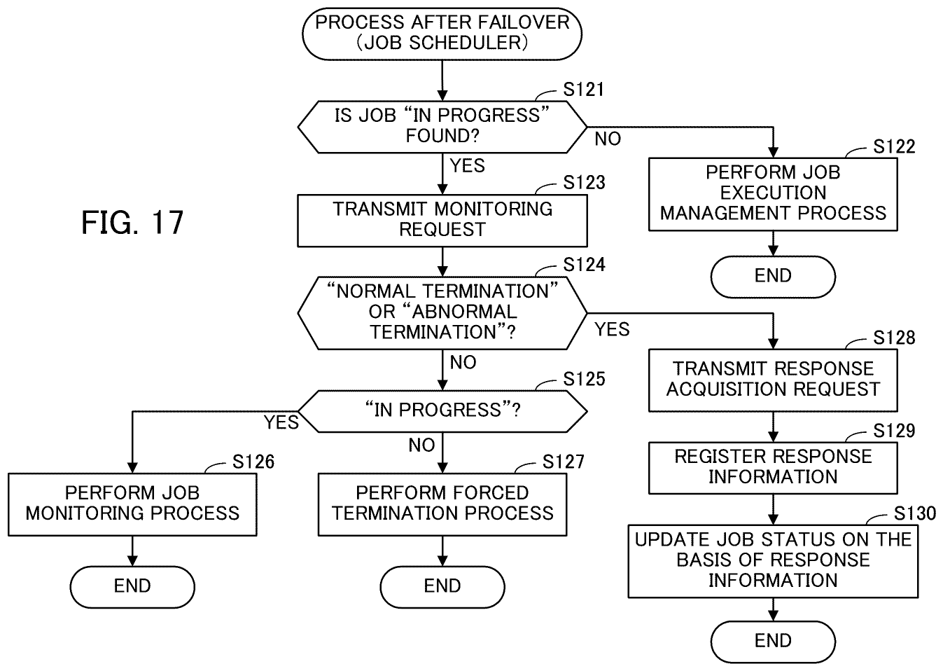

The following describes, with reference to FIG. 17, a process that is performed in the case where the job management machine 110 stops and the job management machine 120 transitions from the standby system to the active system (in a case of failover).

FIG. 17 is a flowchart illustrating an example of a process performed by a job scheduler after failover.

[Step S121] The job scheduler 121 of the job management machine 120 that has transitioned from the standby system to the active system due to failover searches the job management table 131 for a job whose job status is “in progress”. If such a job is found, the process proceeds to step S123. If no such a job is found, the process proceeds to step S122.

[Step S122] The job scheduler 121 performs a job execution management process (corresponding to the process of FIG. 11) for the next job to be executed.

Step S123 and subsequent steps are executed for each job whose job status is “in progress”.

[Step S123] The job scheduler 121 extracts the job ID from the record corresponding to the job in the job management table 131, and transmits a monitoring request having the extracted job ID and tenant ID set therein, to the relay processing unit 210.

[Step S124] The job scheduler 121 receives a response to the monitoring request and extracts a job status from the response. If the job status is either “normal termination” or “abnormal termination”, the process proceeds to step S128. If the job status is neither “normal termination” nor “abnormal termination”, the process proceeds to step S125.

[Step S125] If the job status is “in progress”, the process proceeds to step S126. If the job status is not “in progress”, the process proceeds to step S127.

[Step S126] The job scheduler 121 perform the job monitoring process illustrated in FIG. 12 for the job. In this case, the job scheduler 121 that has been activated by the failover is able to take over the job monitoring process for the job in progress from the job scheduler 111, using only the job ID and the tenant ID specified by the job execution requesting side without using the execution ID specified by the cloud system side.

[Step S127] This step relates to a case where the failover is performed immediately after the execution of the forced termination process (FIG. 15) for the job starts, and the forced termination request has not reached the relay processing unit 210. In this case, the job scheduler 121 performs the forced termination process illustrated in FIG. 15 for the job.

[Step S128] The job scheduler 121 transmits a response acquisition request to the relay processing unit 210 to obtain response information. In the response acquisition request to be transmitted, the same job ID and tenant ID as used in step S123 are set.

The relay processing unit 210 that has received the response acquisition request detects the record including the job ID and the tenant ID from the relay job management table 221, extracts response information from the detected record, and returns the response information to the job scheduler 121.

[Step S129] The job scheduler 121 registers the response information returned from the relay processing unit 210 in the response information field of the record corresponding to the job in the job management table 131.

[Step S130] The job scheduler 121 updates the job status of the record to “normal termination” or “abnormal termination” on the basis of the job status included in the response information.

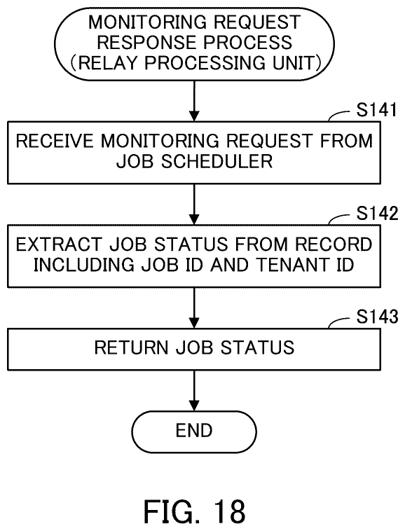

FIG. 18 is a flowchart illustrating an example of a monitoring request response process performed by the relay processing unit.

[Step S141] The relay processing unit 210 receives a monitoring request from either the job scheduler 111 or the job scheduler 121. The monitoring request is, for example, the request transmitted in step S71 of FIG. 12 or step S123 of FIG. 17.

[Step S142] The relay processing unit 210 extracts the job ID and the tenant ID from the received monitoring request. The relay processing unit 210 detects the record including the extracted job ID and tenant ID from the relay job management table 221, and extracts the job status from the detected record.

[Step S143] The relay processing unit 210 returns the extracted job status to the job scheduler that has transmitted the monitoring request.

By the way, the job management system according to the present embodiment enhances the availability of the job management machines 110 and 120. On the other hand, the availability of the relay processing unit 210 is also demanded. Although the relay processing unit 210 may be made redundant using a separate physical machine, this approach increases the time needed for failover and the device cost for the redundancy. By contrast, in the present embodiment, as described above, the relay processing unit 210 is implemented as a container or a serverless function in a virtual execution environment. This allows for fast activation of the relay processing unit 210 that takes over processing, while suppressing the device cost.

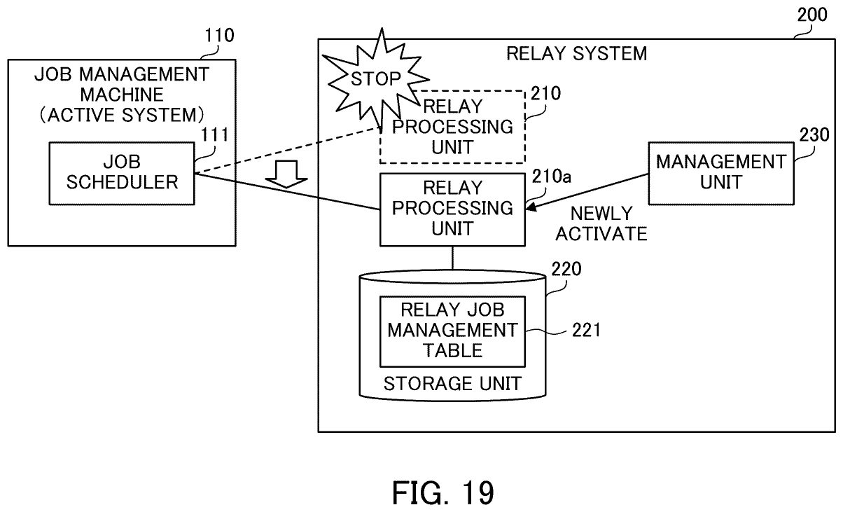

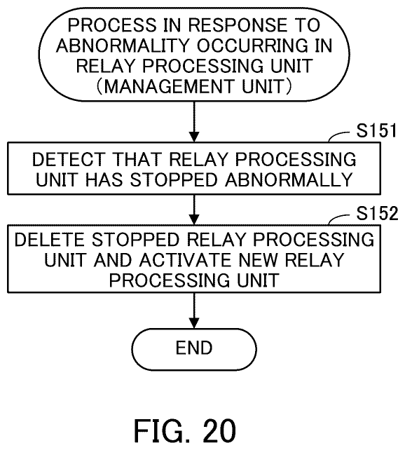

FIG. 19 illustrates a process that is performed when an abnormality occurs in a relay processing unit. In the example of FIG. 19, it is assumed that an abnormality occurs in the relay processing unit 210 that then stops its operation. In this case, the management unit 230 deletes the relay processing unit 210 and activates a new relay processing unit 210a. The relay processing unit 210a takes over the processes that have been performed by the relay processing unit 210, with reference to the relay job management table 221 that has been referenced by the relay processing unit 210. As a result, the processes for jobs whose requests have been received by the relay processing unit 210 are continued by the new relay processing unit 210a. FIG. 20 is a flowchart illustrating an example of a process that is performed by the management unit in response to an abnormality occurring in the relay processing unit.

[Step S151] The management unit 230 detects that the relay processing unit 210 has stopped abnormally.

[Step S152] The management unit 230 deletes the stopped relay processing unit 210 and activates a new relay processing unit 210a. The activated relay processing unit 210a takes over the processes for jobs whose requests have been received by the stopped relay processing unit 210. In addition, requests transmitted from the job management machines 110 and 120 thereafter are received by the activated relay processing unit 210a.

FIG. 21 is a flowchart illustrating an example of a process that is performed by the job scheduler in response to an abnormality occurring in the relay processing unit. The process of FIG. 21 corresponds to each process of step S55 in FIG. 11, step S73 in FIG. 12, and step S103 in FIG. 15, and is executed by one of the job schedulers 111 and 121.

[Step S161] The job scheduler enters a sleep state for a predetermined period of time. When the predetermined period of time has elapsed, the sleep state is canceled, and the process proceeds to step S162.

[Step S162] The job scheduler retransmits a request to the relay processing unit 210. In the case of step S55, the execution request for the job transmitted in step S53 is retransmitted. In the case of step S73, the monitoring request transmitted in step S71 is retransmitted. In the case of step S103, the forced termination request transmitted in step S101 is retransmitted.

[Step S163] The job scheduler determines whether an abnormality has occurred with respect to a response that is returned from the relay processing unit 210 in response to the transmitted request. For example, if no response is transmitted from the relay processing unit 210 or if the response returned indicates an abnormality, the job scheduler determines that an abnormality has occurred, and the process proceeds to step S164. On the other hand, if a response is transmitted properly from the relay processing unit 210, the process proceeds to step S165.

[Step S164] The job scheduler determines whether the number of retransmissions of the request (the number of executions of step S162) has reached a predetermined upper limit. If the number of retransmissions is less than the upper limit, the process proceeds to step S161. On the other hand, if the number of retransmissions has reached the upper limit, a timeout occurs, so that the process ends.

[Step S165] If the abnormality has occurred during the job execution management process (in the case of step S55), the process proceeds to step S56 of FIG. 11. On the other hand, if no abnormality has occurred during the job execution management process, the process proceeds to step S166.

[Step S166] If the abnormality has occurred during the monitoring process (in the case of step S73), the process proceeds to step S74 of FIG. 12. On the other hand, if the abnormality has occurred during the forced termination process (in the case of step S103), the process proceeds to step S104 of FIG. 15.

Here, for example, when the relay processing unit 210 stops abnormally in step S151 of FIG. 20, an abnormality occurs with respect to a response that is made in response to a request made from the job scheduler, and the job scheduler starts the process of FIG. 21. In FIG. 21, the job scheduler retransmits the request to the relay processing unit 210 at predetermined time intervals. When the new relay processing unit 210a is activated before the number of retransmissions reaches the upper limit (corresponding to step S152 in FIG. 20) and returns a normal response, the job scheduler continues processing, with the new relay processing unit 210a designated as the transmission destination of the request. Through this processing, the job scheduler is able to continue the job execution management process without being aware of an abnormal stop of the relay processing unit serving as the request transmission destination or failover.

The following further describes the activation and deletion of the relay processing unit 210. One possible method of activating the relay processing unit 210 is a method in which, every time the start of execution of a job is requested from one of the job management machines 110 and 120, an individual relay processing unit 210 corresponding to the job is generated and activated. However, a certain amount of time and resources are needed to activate and stop the relay processing unit 210. In the case where a relay processing unit 210 is generated for each job, a large number of relay processing units 210 are activated. The activation of each relay processing unit 210 takes time and consumes resources. Therefore, the processing load on the relay system 200 may increase, and the processing speed of the entire job management system may decrease.

To address this, the present embodiment sets an upper limit for the number of jobs that a single relay processing unit 210 is able to handle, and when a job is requested beyond the upper limit, a new relay processing unit 210 is activated to process the requested job.

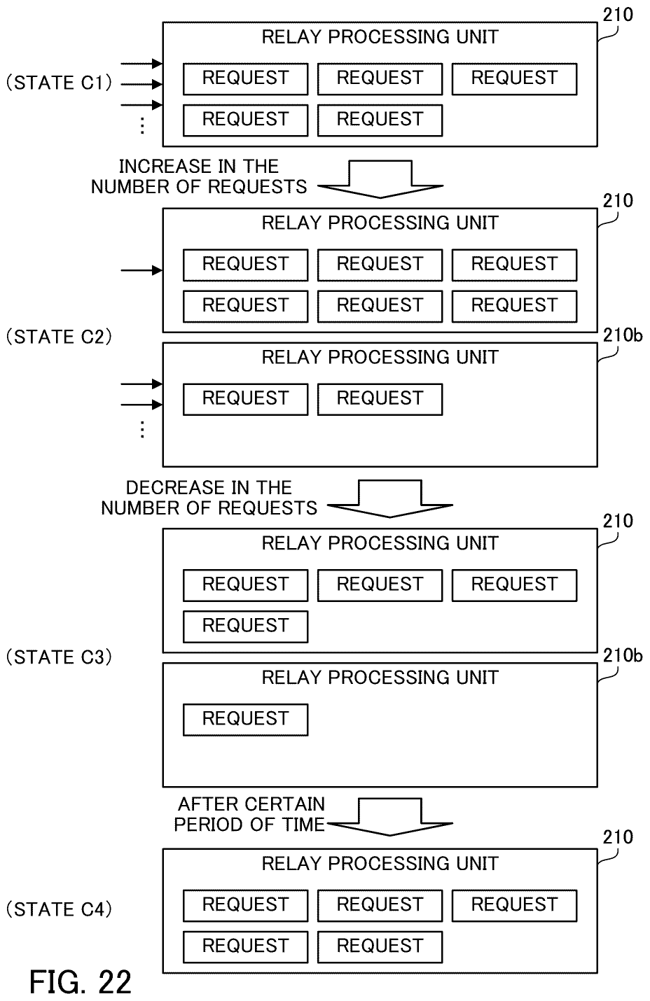

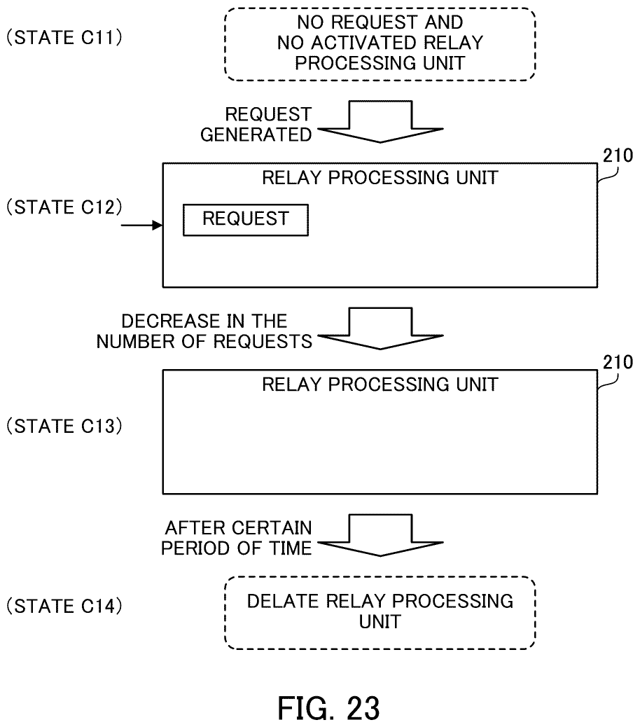

FIG. 22 is a first diagram illustrating an example of activation and deletion of a relay processing unit. FIG. 22 and the subsequent FIG. 23 assume, as an example, that the upper limit of the number of jobs that a single relay processing unit is able to handle is six. Each “request” in FIGS. 22 and 23 corresponds to one job, and the requests include an execution request, a monitoring request, a forced termination request, and a response acquisition request.

In state C1 of FIG. 22, the relay processing unit 210 processes five job requests made from the job management machine 110. It is also assumed that the execution of new jobs is further requested in this state C1 and the number of job requests increases. In state C2, the total number of jobs is eight. When the number of jobs has reached seven, the management unit 230 activates a new relay processing unit 210b and causes the new relay processing unit 210b to process requests for the seventh and subsequent jobs.

After that, it is assumed that the execution of some jobs is complete, thereby decreasing the number of job requests. In state C3, the number of jobs handled by the relay processing unit 210 is reduced to four, whereas the number of jobs handled by the relay processing unit 210b is reduced to one. That is, the total number of jobs in progress is reduced to five. When a state in which the total number of jobs in progress is equal to or less than the upper limit of six continues for a certain period of time, the management unit 230 deletes one relay processing unit and causes the other relay processing unit to handle the execution of the jobs in progress. In the example of FIG. 22, when the certain period of time has elapsed, the relay processing unit 210b is deleted and the relay processing unit 210 executes the jobs in progress, as in state C4.

Through this auto-scaling control by the management unit 230, the number of activated relay processing units 210 is suppressed, so as to reduce overhead caused by processing time and resource consumption for activation and deletion. As a result, the processing load of the relay system 200 is reduced, which prevents a decrease in the processing speed of the entire job management system. In addition, since the upper limit is set for the number of jobs that a single relay processing unit 210 is able to handle, the processing load is distributed among a plurality of relay processing units 210, thereby preventing processing overload on each relay processing unit 210.

FIG. 23 is a second diagram illustrating an example of activation and deletion of a relay processing unit. In state C11 of FIG. 23, no job request is generated. In this state, the management unit 230 does not activate any relay processing unit 210. When a job request is generated thereafter, as in state C12, the management unit 230 activates a relay processing unit 210 and causes the activated relay processing unit 210 to receive the job request and to handle the execution of the job.

After that, it is assumed that the job has completed execution and the number of jobs in progress becomes zero, as in state C13. When this state, in which the number of jobs in progress is zero, continues for a certain period of time, the management unit 230 deletes the relay processing unit 210 as in state C14.

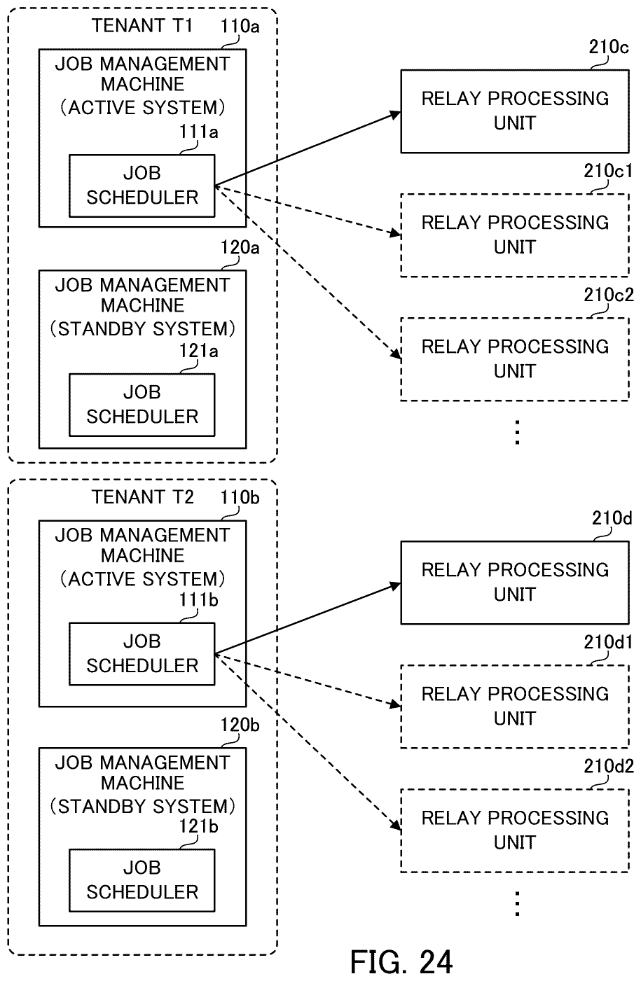

In this way, by activating the relay processing unit 210 only when a job request is generated, it becomes possible to eliminate a waste of resource consumption and to improve the efficiency of use of the relay system 200. For example, in the case where the relay processing unit 210 is activated on a per-tenant basis, as described below with reference to FIG. 24, a relay processing unit 210 is activated only for a tenant that has generated a job request. This further improves the efficiency of use of the resources of the relay system 200.

The following describes the relationship between tenants and relay processing units 210. The relay system 200 is able to provide tenant-dedicated relay processing units 210 and tenant-shared relay processing units 210. A customer is able to select whether to use the tenant-dedicated relay processing units 210 or the tenant-shared relay processing units 210.

FIG. 24 illustrates tenant-dedicated relay processing units. In the example of FIG. 24, a job management machine 110a as an active system and a job management machine 120a as a standby system belong to a tenant T1, and a job management machine 110b as an active system and a job management machine 120b as a standby system belong to a tenant T2. The job management machine 110a includes a job scheduler 111a, and the job management machine 120a includes a job scheduler 121a. The job management machine 110b includes a job scheduler 111b, and the job management machine 120b includes a job scheduler 121b.

In FIG. 24, a relay processing unit 210c dedicated to the tenant T1 and a relay processing unit 210d dedicated to the tenant T2 are both activated. The relay processing unit 210c processes job requests from the job scheduler 111a (or the job scheduler 121a). As the number of jobs increases, additional relay processing units 210cl, 210c2, and dedicated to the tenant T1 may be activated. Similarly, the relay processing unit 210d processes job requests from the job scheduler 111b (or the job scheduler 121b). As the number of jobs increases, additional relay processing units 210d1, 210d2, and dedicated to the tenant T2 may be activated.

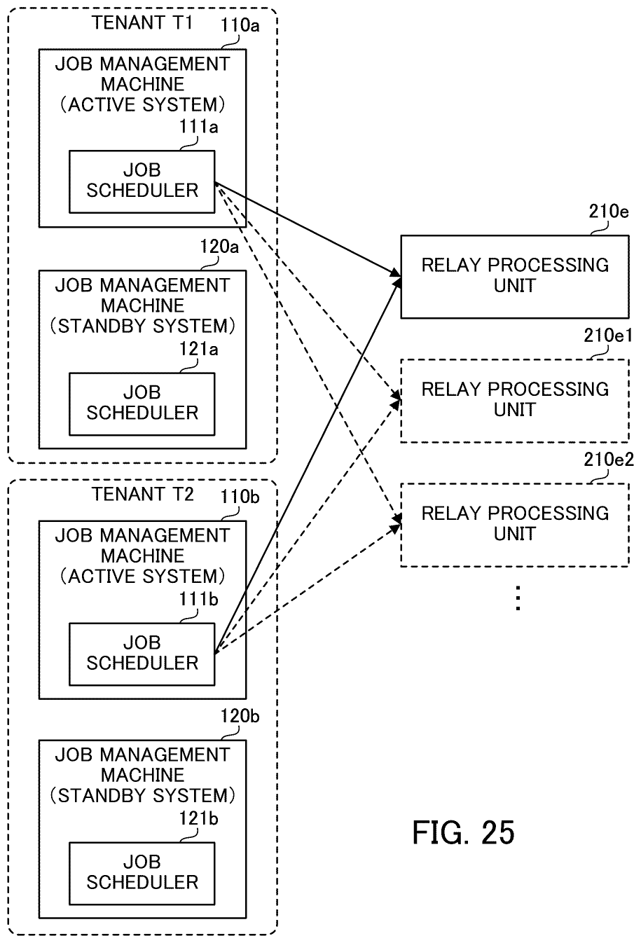

Each of the above tenant-dedicated relay processing units is able to perform processing for jobs, without being affected by the processing load of other tenants or by maintenance or update conducted for the systems of other tenants. FIG. 25 illustrates tenant-shared relay processing

units. In the example of FIG. 25, the job management machines 110a, 120a, 110b, and 120b are provided, as in FIG. 24. However, unlike FIG. 24, in FIG. 25, a relay processing unit 210e shared by the tenants T1 and T2 is activated. The relay processing unit 210e processes job requests from the job scheduler 111a (or the job scheduler 121a) and job requests from the job scheduler 111b (or the job scheduler 121b). As the number of jobs increases, additional relay processing units 210e1, 210e2, and shared by the tenants T1 and T2 may be activated.

By configuring such tenant-shared relay processing units, it becomes possible to reduce system deployment and operation costs for each tenant.

The processing functions of each of the apparatuses described in the above embodiments (for example, the job management apparatuses 11 and 12, the relay system 20, the job execution system 30, the job management machines 110 and 120, the relay system 200, and the cloud systems 310, 320, and 330) may be implemented by a computer. In this case, a program is provided, which describes processing contents for the functions of an individual apparatus. A computer implements the processing functions by running the program. The program describing the processing contents may be stored on a computer-readable storage medium. Computer-readable storage media include magnetic storage devices, optical discs, semiconductor memories, and others. Magnetic storage devices include hard disk drives (HDDs), magnetic tapes, and others. Optical discs include compact discs (CDs), digital versatile discs (DVDs), Blu-ray discs (BDs, registered trademark), and others.

To distribute the program, portable storage media, such as DVDs and CDs, on which the program is stored, may be put on sale, for example. Alternatively, the program may be stored in a storage device of a server computer and may be transferred from the server computer to other computers over a network.

A computer that is to run the above program stores in its local storage device the program recorded on a portable storage medium or transferred from the server computer, for example. Then, the computer reads the program from the local storage device and runs the program. The computer may run the program directly from the portable storage medium. Alternatively, the computer may sequentially run the program while receiving the program being transferred from the server computer over a network.

In one aspect, it is possible to achieve a reliable failover to a job management apparatus.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A job management system comprising:
a first job management apparatus configured to perform
an execution request process of transmitting a first request that specifies first identification information identifying a job to request a start of execution of the job, and
a monitoring process of repeatedly transmitting a second request that specifies the first identification information to request status information indicating an execution status of the job, after the transmitting of the first request and until the status information returned in response to the second request indicates an end of the execution of the job;
a second job management apparatus configured to take over the monitoring process from the first job management apparatus by using the first identification information;
a relay system configured to perform a relay process that includes
transferring, upon receiving the first request from the first job management apparatus, the first request to a job execution system that is to execute the job,
receiving second identification information identifying the job from the job execution system and storing the first identification information and the second identification information in association with each other in a memory,
transmitting, to the job execution system, a third request that specifies the second identification information to request the status information, and storing the status information returned from the job execution system in association with the first identification information in the memory, and
obtaining, upon receiving the second request from the first job management apparatus or a fourth request specifying the first identification information from the second job management apparatus, the status information associated with the first identification information from the memory and transmitting the status information to the first job management apparatus having transmitted the second request or the second job management apparatus having transmitted the fourth request; and
the job execution system configured to start, upon receiving the second request from the relay system, the execution of the job, assign the second identification information to the job, and transmit the second identification information to the relay system, and
transmit, upon receiving the third request from the relay system, the status information of the job to the relay system.

2. The job management system according to claim 1, wherein
the second job management apparatus transmits, in response to the first job management apparatus stopping operation, the second request to the relay system, and
the second job management apparatus repeatedly transmits, in response to the status information returned from the relay system indicating that the job is in progress, the second request until the status information returned from the relay system indicates the end of the execution of the job.

3. The job management system according to claim 1, wherein
the relay process is performed using a first execution environment virtually configured in the relay system, and
in response to an abnormality occurring in the first execution environment, the relay system deletes the first execution environment, virtually configures a second execution environment anew, and takes over the relay process using the second execution environment.

4. The job management system according to claim 3, wherein each of the first execution environment and the second execution environment is a container or a serverless function.

5. The job management system according to claim 3, wherein
the relay system causes the first execution environment to perform the relay process for a predetermined number or less of jobs, and
in response to the job being requested for execution beyond the predetermined number, the relay system virtually configures a third execution environment anew and causes the third execution environment to perform the relay process for the job exceeding the predetermined number.

6. The job management system according to claim 5, wherein, in response to a total number of jobs for which the relay process is performed using the first execution environment and the third execution environment being less than or equal to the predetermined number, the relay system causes the first execution environment to perform the relay process for the jobs and deletes the third execution environment.

7. The job management system according to claim 3, wherein
a plurality of combinations each including the first job management apparatus and the second job management apparatus are provided, and the relay system performs the relay process in response to requests from the plurality of combinations, using the first execution environment that is commonly shared by the plurality of combinations.

8. The job management system according to claim 3, wherein
a plurality of combinations each including the first job management apparatus and the second job management apparatus are provided, and the relay system performs the relay process in response to a request from one combination among the plurality of combinations, using the first execution environment that is dedicated to the one combination.

9. A non-transitory computer-readable storage medium storing a computer program that causes a computer to perform a relay process comprising:
transferring, upon receiving a first request that specifies first identification information identifying a job to request a start of execution of the job, from a first job management apparatus, the first request to a job execution system that is to execute the job, receiving second identification information identifying the job from the job execution system, and storing the first identification information and the second identification information association with each other in a memory;
transmitting, to the job execution system, a third request that specifies the second identification information to request status information indicating an execution status of the job, and storing the status information returned from the job execution system in association with the first identification information in the memory;
obtaining, upon receiving a second request that specifies the first identification information to request the status information, from the first job management apparatus, the status information associated with the first identification information from the memory, and transmitting the status information to the first job management apparatus; and
obtaining, upon receiving a fourth request specifying the first identification information from a second job management apparatus that has taken over a monitoring process of monitoring the execution status of the job from the first job management apparatus, the status information associated with the first identification information from the memory, and transmitting the status information to the second job management apparatus.

10. The non-transitory computer-readable storage medium according to claim 9, wherein
the relay process is performed using a first execution environment virtually configured in the computer, and
in response to an abnormality occurring in the first execution environment, the computer deletes the first execution environment, virtually configures a second execution environment anew, and takes over the relay process using the second execution environment.

11. An information processing method comprising:
performing, by a processor, a relay process including:
transferring, upon receiving a first request that specifies first identification information identifying a job to request a start of execution of the job, from a first job management apparatus, the first request to a job execution system that is to execute the job, receiving second identification information identifying the job from the job execution system, and storing the first identification information and the second identification information in association with each other in a memory;
transmitting, to the job execution system, a third request that specifies the second identification information to request status information indicating an execution status of the job, and storing the status information returned from the job execution system in association with the first identification information in the memory;
obtaining, upon receiving a second request that specifies the first identification information to request the status information, from the first job management apparatus, the status information associated with the first identification information from the memory, and transmitting the status information to the first job management apparatus; and
obtaining, upon receiving a fourth request specifying the first identification information from a second job management apparatus that has taken over a monitoring process of monitoring the execution status of the job from the first job management apparatus, the status information associated with the first identification information from the memory, and transmitting the status information to the second job management apparatus.
